(19) United States
(12) Patent Application Publication
(10) Pub. No.: US 2026/0230513 A1
(43) Pub. Date: Aug. 6, 2026

(54) PROTOCOL DATA UNIT (PDU) SET INFORMATION FOR HAPTICS MEDIA DATA

(71) Applicant: InterDigital VC Holdings, Inc., Wilmington, DE (US)

(72) Inventors: Srinivas Gudumasu, Montreal (CA); Ahmed Hamza, Coquitlam (CA); Gaëlle Martin-Cocher, Toronto (CA)

(21) Appl. No.: 19/043,502

(22) Filed: Feb. 2, 2025

(51) Int. Cl. H04L 65/75

(52) U.S. Cl. CPC H04L 65/762; H04L 2212/00

(57) ABSTRACT

Protocol Data Unit (PDU) Set Information for Haptics Media Data, A method includes determining, with an electronic processor, haptic media characteristics. The method includes generating, with the electronic processor, a haptics media RTP packets/PDUs based on the haptic media characteristics, the haptics media RTP packets/PDUs including a payload with haptic data and a payload header extension including an importance value from a plurality of importance values, the importance value indicating an importance of the haptic data and assign based on the haptic media characteristics. The method also includes outputting, with the electronic processor, the haptics media RTP packets/PDUs.

### BACKGROUND

The present disclosure relates generally to wireless communication. More specifically, examples described herein relate to encoding and decoding haptic media streams containing haptic data.

### BRIEF SUMMARY

Briefly stated, in one embodiment, a method includes determining, with an electronic processor, haptic media characteristics. The method includes generating, with the electronic processor, a haptics media RTP packets/PDUs based on the haptic media characteristics, the haptics media RTP packets/PDUs including a payload with haptic data and a payload header extension including an importance value from a plurality of importance values, the importance value indicating an importance of the haptic data and assign based on the haptic media characteristics. The method also includes outputting, with the electronic processor, the haptics media RTP packets/PDUs.

In another embodiment, a method includes receiving, with a electronic processor, a haptics media RTP packets/PDUs based on haptic media characteristics, the haptics media RTP packets/PDUs including a payload with haptic data. The method includes determining, with the electronic processor, whether a payload header extension of the haptics media RTP packets/PDUs includes an importance value from a plurality of importance values, the importance value indicating an importance of the haptic data. The method also includes decoding, with the electronic processor, the payload from the haptics media RTP packets/PDUs based on the importance value.

### BRIEF DESCRIPTION OF THE DRAWINGS

The following detailed description will be better understood when read in conjunction with the appended drawings, in which there are shown examples of one or more of the multiple embodiments of the present disclosure. It should be understood, however, that the embodiments described herein are not limited to the precise arrangements and instrumentalities shown in the drawings. In the drawings:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a flowchart illustrating a hierarchical organization of a data structure of a MPEG haptic media format according to an embodiment;

FIG. 3 is a diagram illustrating how a haptic signal can be decomposed in two frequency bands according to an embodiment;

FIG. 4 is a diagram illustrating a RTP header as defined in IETF;

FIG. 5 is a diagram illustrating a RTP Payload Header for haptics media;

FIG. 6 is a diagram illustrating a list of unit type values according to an embodiment;

FIG. 7 is a diagram illustrating a one-byte RTP HE for the marking of PDU Sets and End of Bursts according to an embodiment;

FIG. 8 is a diagram illustrating a two-byte RTP HE for the marking of PDU Sets and End of Bursts according to an embodiment;

FIG. 9 is a diagram illustrating a fragmented unit payload structure in an RTP packet according to an embodiment.

FIG. 10 is a diagram illustrating a structure of the FU header according to an embodiment;

FIG. 11 is a table illustrating a haptics extension of the definition of MediaType according to an embodiment;

FIG. 12 is a diagram illustrating an example media representation corresponding to the hmpg RTP payload in SDP according to an embodiment;

FIG. 13 is a diagram illustrating an example media representation corresponding to the hmpg RTP payload with PDU Set Marking RTP HE in SDP according to an embodiment;

FIG. 14 is a diagram illustrating a one-byte RTP HE for the marking of PDU sets according to an embodiment;

FIG. 15 is a diagram illustrating a two-byte RTP HE for the marking of PDU sets according to an embodiment;

FIG. 16 is a flowchart illustrating an example method of encoding haptics media RTP data according to an embodiment; and

FIG. 17 is a flowchart illustrating an example method of decoding haptics media RTP data according to an embodiment.

### DETAILED DESCRIPTION

In describing the various embodiments of the present disclosure, certain terminology is used herein for convenience only and should not be considered as limiting such embodiments. In the drawings, the same reference numerals are employed for designating the same elements throughout the several figures and the present description.

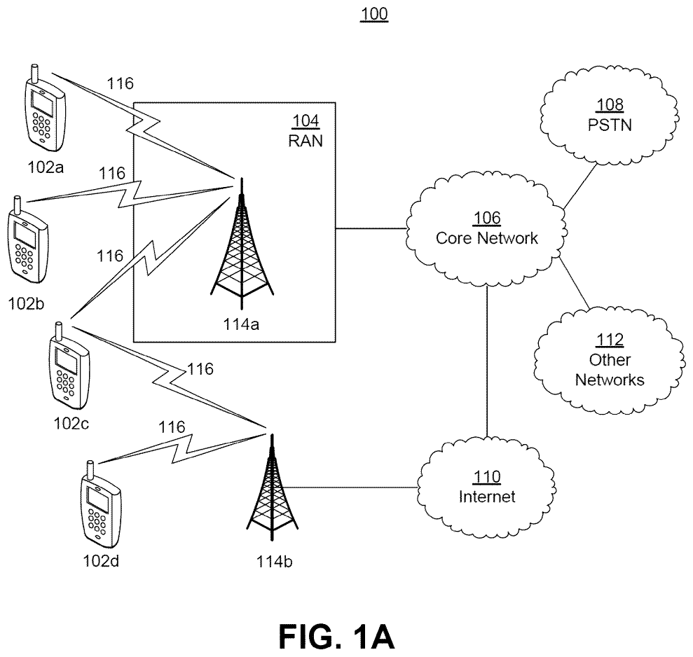

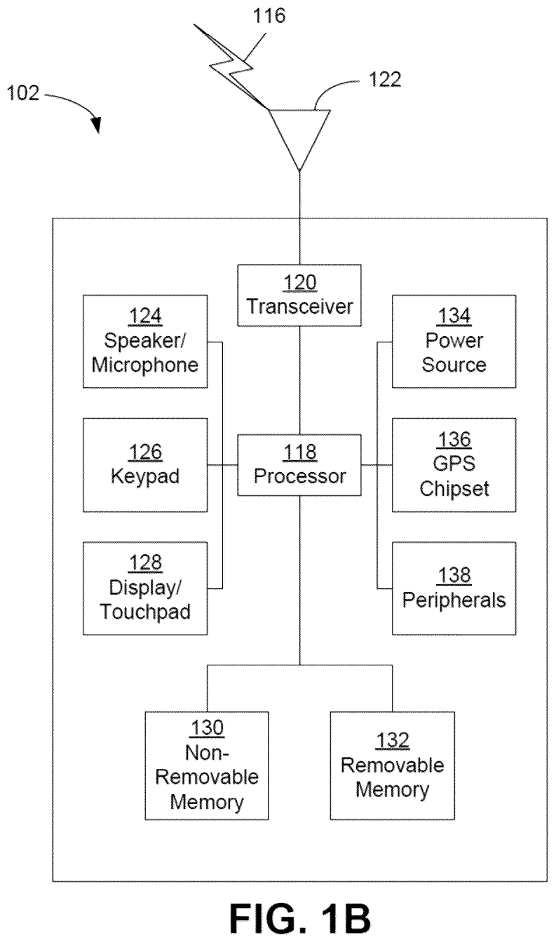

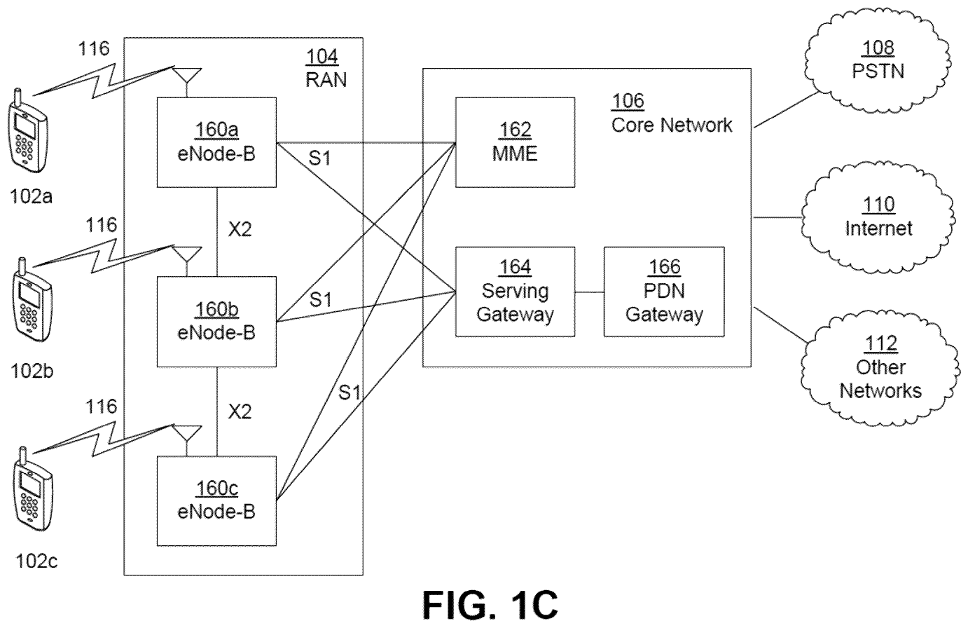

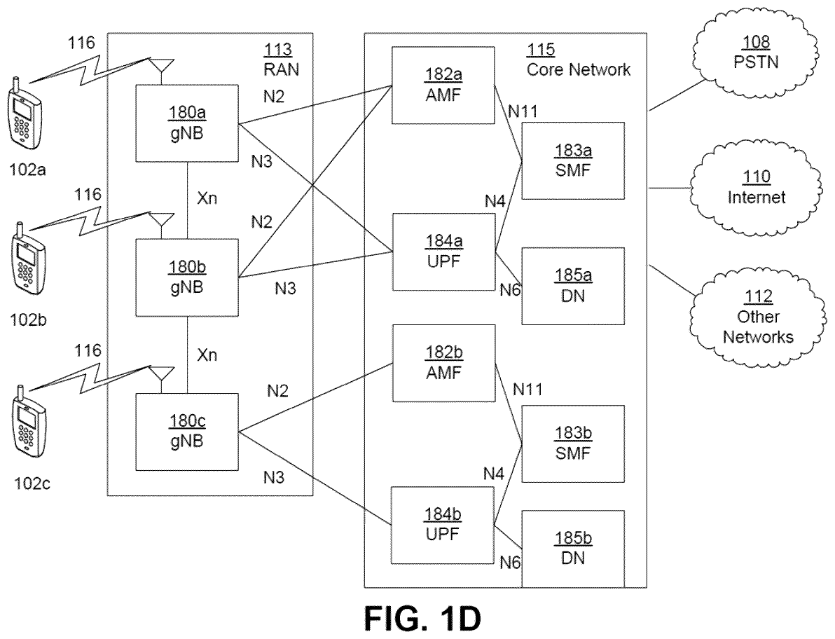

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 602.11 (i.e., Wireless Fidelity (WiFi), IEEE 602.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 656 (IS-656), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 602.11 to establish a wireless local area network (WLAN). In an embodiment, the base station 114b and the WTRUs 102c, 102d may implement a radio technology such as IEEE 602.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 602 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 602.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 602.11e DLS or an 602.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 602.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 602.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 602.11af and 602.11ah. The channel operating bandwidths, and carriers, are reduced in 602.11af and 602.11ah relative to those used in 602.11n, and 602.11ac. 602.11af supports 5 MHz, 10 MHz and 20 MHz bandwidths in the TV White Space (TVWS) spectrum, and 602.11ah supports 1 MHz, 2 MHz, 4 MHz, 8 MHz, and 16 MHz bandwidths using non-TVWS spectrum. According to a representative embodiment, 602.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 602.11n, 602.11ac, 602.11af, and 602.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 602.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 602.11ah, are from 702 MHz to 728 MHz. In Korea, the available frequency bands are from 717.5 MHz to 723.5 MHz. In Japan, the available frequency bands are from 716.5 MHz to 727.5 MHz. The total bandwidth available for 602.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Features described herein may be associated with PDU sets. A PDU set may be one or more PDUs carrying the payload of one unit of information generated at the application level (e.g., a frame or video slice for eXtended reality (XR) services).

PDU set importance may be an importance of a PDU set within a QoS flow. The NG-RAN may use the PDU set importance for PDU set level packet discarding in presence of congestion.

PDU set information may be different for different PDU sets within a QoS flow. A mechanism may not be defined for how and whether PDU set importance is interpreted across QoS flow. A mechanism may not be defined for how the WTRU and RAN determine when to use PDU set importance to make packet discarding decisions, when to use a QoS flow priority level to make packet discarding decisions, and when to use a combination of PDU set importance and a QoS flow priority level to make packet discarding decisions.

Features described herein may be associated with QoS flows. A UPF may assign downlink packets to a QoS flow based on rules (e.g., N4 rules) that are configured in the UPF by the SMF. The WTRU may assign uplink packets to a QoS flow based on QoS rules that are configured in the WTRU by the SMF. QoS rules may be sent to the WTRU in a PDU session establishment accept message or a PDU session modification command message.

A QoS flow may be identified with a QoS flow ID (QFI). The QFI (e.g., in the downlink) may be carried from the UPF to the RAN in an encapsulation header (e.g., on N3 and/or N9). The (R)AN may map PDUs from QoS flows to access-specific resources based on the QFI and an associated QoS profile (e.g., an associated 5G QoS profile). The QoS profile that is associated with a QFI may be configured in the RAN by the SMF.

In the downlink, the SMF may configure the UPF to detect what QoS flow a downlink packet maps to, and the SMF may configure the RAN with information about the forwarding treatment for a QoS flow.

In the uplink, the SDAP layer may use the QoS rules and the QFI of the QoS flow to determine a DRB for the packet. The packet and selected DRB may be sent from the SDAP layer to the lower layers. The lower layers may use the DRM to map the PDU to access-specific resources. The QoS profile that is associated with a QFI may be configured in the RAN by the SMF.

In the uplink, the SMF may configure the WTRU to detect what QoS flow an uplink packet maps to, and the SMF may configure the WTRU with information about the forwarding treatment for a QoS flow.

Different types of media may map to the same QoS flow. In examples, if two types of media (e.g., video and haptic feedback) have similar delay budget characteristics (e.g., requirements), both types of media may map to the same QoS flow. A single QoS flow may carry multiple types of media flows or data flows.

A QoS flow may be associated with a priority level. In the downlink, the SMF may configure a network node (e.g., a RAN/RAN node) with information about the forwarding treatment for a QoS flow. A QoS flow may be associated with a 5QI value. A 5QI value may be translated into the following characteristics used in the DL to determine the packet forwarding treatment: A resource type (e.g., non-GBR, GBR, delay-critical GBR); a priority level; a packet delay budget (e.g., including core network packet delay budget); a packet error rate; an averaging window (e.g., for GBR and delay-critical GBR resource type); and a maximum data burst volume (e.g., for delay-critical GBR resource type).

For a QFI, the QoS profile may indicate a 5QI value and a priority level that is associated with the QFI. When a priority level is included in the QoS Profile, the priority in the QoS Profile may override the priority level that is associated with the 5QI. The priority level in the QoS Profile may override the priority level that is associated with the 5QI in the mapping table.

The priority level associated with 5G QoS characteristics may indicate a priority in scheduling resources among QoS flows.

The SMF may provide packet detection rules (PDR) to the UPF. The PDRs may be associated with QoS enforcement rules (QER). When the UPF detects that a packet matches the PDR, the QER may be applied.

A PDR may include an IP packet filter set, and if traffic matches the IP filter, QER may be applied. The PDR may include an application ID. The application ID may be an index to a set of application detection rules configured in the UPF. The application detection rule may be more granular than a simple IP filter.

Packet flow descriptions (PFDs) may be sent to the SMF, and the SMF may provide the PFDs to the UPF. A PFD may contain application detection rules. As mentioned herein, the rules may be more granular than an IP filter (e.g., a simple IP filter). In examples, a descriptor may include a simple IP Filter or URLs that may be matched (or domain names, or protocols). The PFD may have an application ID.

When the SMF gets a PFD, the SMF may look at the application ID of the PFD and check what PDRs have the same application ID. The SMF may check what UPFs have the PDRs with the matching application ID. The SMF may send the PFD to the UPFs (e.g., all of the UPFs that the SMF identified).

The SMF may send QoS rules to the WTRU and sends QER to the UPF. There may be no PFD-like functionality in the WTRU. The network may tell the WTRU to apply a certain QFI value to a certain IP flow, and the network may not tell the WTRU to apply a certain QFI value when it detects a particular URL name.

Packet importance may be derived from application layer headers. application layer Messages may be carried via protocols that indicate the type of payload carried in the message. In examples, an RTP message may carry (e.g., different) types of payloads. The format of the RTP header may vary depending on the payload type. For (e.g., some) payload types, the header may include an indication of the type of packet. In examples, when the RTP payload carries H.265 data, the RTP header may include a NAL unit type indication that indicates if the payload is a single NAL unit packet, part of an aggregation of packets, fragmentation units, or PACI packet. The NAL unit type indication may be used to indicate the importance of the payload.

A (e.g., different) type of application layer protocol is MOQ. In MOQ, the application may set an importance value or preferred delivery order with no absolute meaning. The importance value may indicate importance relative to the importance of the surrounding application layer messages.

The SDAP layer of the WTRU may map QoS flows to DRBs. One or more QoS flows may be mapped onto one DRB. One QoS flow may be mapped onto one DRB at a time in the UL.

In the downlink, the UPF may be configured with rules that the UPF can use to detect the format of the media that is carried in a PDU set. When the format of a PDU set is detected, the UPF may use information that is included in the header of the PDU to determine what PDU set importance to assign to the PDU set. In examples, if the UPF detects that the format of the PDU set is H.266 RTP, the UPF may use the NAL unit type field of the header to determine a PDU set importance value. If the PDU set importance value is a 4-bit value, then an example of a straightforward mapping from the NAL unit type field value to a PDU set importance value may be as follows.

The UPF may assign a PDU set importance value of 1 for (e.g., all) NAL unit type values from 0-25. The UPF may assign a PDU set importance value of 3 for (e.g., all) NAL unit type values of 28. The UPF may assign a PDU set importance value of 2 for (e.g., all) NAL unit type values of 29. The UPF may assign a PDU set importance value of 0 for (e.g., all) NAL unit type values of 26-27 and 30-31.

In examples described herein, that the media format types that are carried in a QoS flow may vary may not be considered. In examples, a QoS flow may carry both H.266 RTP payloads and haptic feedback. Using separate PDU set importance determination rules for a type of media may result in assigning PDU set importance values that that do not accurately reflect the relative importance of a (e.g., each) PDU set. The RAN may be influenced to drop packets that are relatively more important than other packets that are available to be dropped in other QoS flows.

It may not be practical for application developers to set an application-layer importance and an importance value that is specific to the network (e.g., the 5G network). The network may determine the importance of a packet based on information that is derived (or detected) in the application layer message (e.g., header or payload).

Example methods may be associated with enabling configuration of the UPF, so that the UPF can detect and indicate the relative importance of PDU sets, e.g., when the QoS flows carry varying types of media.

As described herein, when the RAN node receives PDU sets from UPF(s), the RAN node may use the PDU set importance values to make decisions about what PDU sets may (e.g., should) be dropped during a congestion situation. The PDU set importance value may indicate the relative importance of the PDUs that are carried in the QoS flow, and the RAN node may be configured with information to help determine the importance of a PDU set relative to the PDU sets of (e.g., other) QoS flows. As described above, the priority level of an individual QoS flow indicates the relative importance of a QoS flow relative to other QoS flows. An example of determining what PDU set(s) to drop during a congestion situation may be as follows: available (e.g., any available) PDU sets may be dropped with the lowest importance value in the lowest priority QoS flow. Available (e.g., any available) PDU sets may be dropped with the next highest importance value in the lowest priority QoS flow. The RAN may continue in this manner (e.g., drop PDU sets with the next highest importance value in the lowest priority QoS flow) until (e.g., all) the PDU sets of the lowest priority QoS flow are dropped. The (e.g., all of the) PDU sets of the lowest priority QoS flow may be dropped, and the RAN may begin dropping PDU sets from the next highest priority QoS flow.

In an example described herein, the RAN may drop (e.g., all) the PDU sets from low priority QoS flows while dropping no PDU sets from high priority QoS flows. The fact that the (e.g., all) PDU sets were dropped from the low priority QoS flow may be perceptible to a user. Meanwhile, there may have been PDU sets of relatively low importance that were available to be dropped in a high priority QoS flow. If the PDU set dropping would have been spread out across more QoS flow, the packet dropping may have been less perceptible to the user.

Example methods may be associated with enabling configuration of the RAN so that the RAN can more evenly spread out PDU set dropping events across QoS flows. Such a configuration may not instruct the RAN to make dropping decisions that are spread out evenly across QoS flows and may guide the RAN into making (e.g., more) balanced decisions that are not (e.g., that are less) perceptible to the user.

In the uplink, the WTRU may be configured with rules that the WTRU can use to detect the format of the media that is carried in a PDU set. When the format of a PDU set is detected, the WTRU may use information that is included in the header of the PDU to determine what PDU set importance to assign to the PDU set. In examples, if the WTRU detects that the format of the payload/PDU set is H.264 RTP, the WTRU may use the unit type field of the header to determine a PDU set importance value. If the PDU set importance value is a 4-bit value, a mapping example described herein as taking place in the UPF may take place in the WTRU. The example may result in drawbacks that are described herein. The example may not account (e.g., account well) for the fact that the media format types that are carried in a QoS flow may vary.

Example methods may be associated with enabling configuration of the WTRU, such as the WTRU upper layers (e.g., WTRU SDAP layer), so that the WTRU upper layers can detect and indicate the relative importance of PDU sets when the QoS flows carry varying types of media. The WTRU upper layers may provide relative importance information to the lower layers (e.g., lower layers of the WTRU) so that the lower layer can efficiently (e.g., more efficiently) prioritize PDU sets across QoS flows and within QoS flows. Efficient prioritizing of PDU sets may include lower layers using information that is provided by the SDAP layer to determine how much of a QoS flow with a relatively low priority level may be deprioritized before it is preferable, from a QoE perspective, to deprioritize PDUs from a QoS flow with a relatively higher priority level.

Features described herein may be associated with how a (e.g., 5G) system can be modified in terms of how downlink traffic is handled. The enhancements may describe how the UPF can determine the importance of a PDU set relative to PDU sets that were previously sent in the same QoS flow and provide the importance information to the RAN node. The RAN node may be configured with information so that the RAN can prioritize packets based on the PDU set importance value and the priority level of the QoS flow and based on how much traffic may be discarded from a QoS flow before the user detects a degradation in QoE. The RAN node may select packets for discarding in a way that is less likely to impact the overall user QoE.

Features described herein may be associated with how a (e.g., 5G) system can be modified in terms of how uplink traffic is handled. The enhancements may describe how the WTRU upper layers can determine the importance of a PDU set relative to PDU sets that were previously sent in the same QoS flow and provide the importance information to the WTRU lower layers. The WTRU lower layers may prioritize packets based on the PDU set importance value and the priority level of the QoS flow and based on how much traffic can be discarded from a QoS flow before the user detects a degradation in QoE. The WTRU may prioritize packets in a way that is not likely (e.g., less likely) to impact the overall user QoE.

Features described herein may be associated with downlink handling of PDU set importance. In the downlink, data may be sent from an application server to a WTRU. Data from the application server may enter the (e.g., 5GP) Core network via a UPF. The UPF may use a PDU session of the WTRU to deliver the data to the WTRU via a RAN node. The SMF may configure the UPF and RAN node with information that is used by the UPF and RAN node to determine how to treat (e.g., prioritize) traffic of the PDU session. The following may describe how the SMF, UPF, and RAN node can determine the importance of PDUs, assign an importance value to a PDU, and use the PDU set importance value to prioritize PDUs, such that the user of the WTRU is less likely to notice a degradation in QoE when PDUs are (e.g., need to be) discarded by the network (e.g., RAN node) during periods of congestion. The SMF may configure the UPF and RAN nodes based on PCC rules that were received from the PCF. The PCF may derive the PCC rules based on information that was received from the AF/AS.

In examples (e.g., downlink), relative importance may be identified and relative importance may be conveyed to the RAN node. A UPF may be configured with PDU set importance Assignment rules that the UPF can use to determine the importance of a PDU set relative to the PDU sets that were recently sent from the UPF to the RAN node.

A network node (e.g., a user plane function (UPF)) may receive a rule, such as a packet data unit (PDU) set importance (PDSI) assignment rule, for example, the PDSI rule may be received in a first message (e.g., an N4 message). The PDSI rule may be received from an SMF. As described herein, a PDU set assignment rule and a PDSI assignment rule may be used interchangeably (e.g., the PDU set assignment rule may include the PDSI assignment rule). As described herein, a PDU set base value and a PDSI base value may be used interchangeably (e.g., the PDU set base value may include the PDSI base value). As described herein, a previous PDU set value and a previous PDSI value may be used interchangeably (e.g., the previous PDU set value may include the previous PDSI value).

The PDSI assignment rule may be associated with a QoS flow. The UPF may receive a downlink data packet (e.g., a PDU). The UPF may, based on the PDSI assignment rule and one or more of a PDSI base value or a PDU set importance of a previous downlink data packet (e.g., a previous PDU), determine a PDU set importance value associated with the downlink data packet (e.g., for the downlink data packet). The UPF may send (e.g., in a second message) the downlink data packet and the PDU set importance value of the downlink data packet (e.g., to a RAN node, for example in a GTP-U message).

The PDSI assignment rule may be associated with an application identifier (e.g., an application type). The application identifier may be used to determine that the PDSI assignment rule is to be applied (e.g., the detection of the application identifier may be used to determine that the PDSI assignment rule is to be applied). The application identifier may be used to determine what relative importance determination (RID) rule (e.g., within a PDSI assignment rule) to determine the PDU set importance value to assign to the downlink data packet.

The PDSI assignment rule may be associated with a PDSI base value that indicates a starting value for PDU set importance value.

The PDSI assignment rule may be associated with a PDSI reset trigger that indicates a condition. Based on the condition being satisfied, the UPF may assign the PDSI base value as the PDU set importance value to the downlink data packet.

A protocol data unit (PDU) set importance (PDSI) assignment rule may include information indicative of an assignment rule for PDU set importance (e.g., a priority of a PDU set). PDU set importance and PDSI may be used interchangeably as described herein. PDSI assignment rule, logical rule, priority rule, importance rule, and logical priority rule may be used interchangeably herein. In examples, the PDSI assignment rule may include a logical rule that may determine an importance for a PDU set. In examples, the PDSI assignment rule may include data and/or code that when processed by a processor may determine an importance. In examples, the PDSI assignment rule may include information corresponding to one or more of the following: a protocol discriminator, a security header, an authorization code, a sequence number, a message type, and/or a payload container. The PDSI assignment rule may affect a priority of the PDU with respect to a layer (e.g., a particular layer) of a WTRU. A PDSI assignment rule may include information indicative of a logical rule that may determine the importance (e.g., an objective importance, a relative importance, etc.) of data (e.g., a PDU, PDU set, a QoS flow, or the like). The data may have a priority (e.g., a particular priority) in a layer (e.g., a particular layer). The PDSI assignment rule may correlate to a priority associated with a layer (e.g., high/medium/low).

The reset trigger may indicate a time value, and if a duration between receiving or sending PDU sets for the QoS flow (e.g., the same QoS flow) exceeds the time value (e.g., on a condition that the duration associated with sent or received PDU sets for the QoS flow exceeds the time value), the UPF may assign (e.g., be triggered to assign) the PDSI base value as the PDU set importance value of the next downlink data packet (e.g., a second downlink PDU).

The reset trigger may indicate an application ID (e.g., an application type). If the UPF detects that the downlink packet matches the application detection rule that is identified by the application ID, the UPF may be triggered to assign the PDSI base value as the PDU set importance value of the downlink data packet.

The reset trigger may indicate a protocol/media type/field value combination, and if the UPF detects that the downlink packet matches the combination, the UPF may be triggered to assign the PDSI base value as the PDU set importance value of the downlink data packet.

The PDSI assignment rule may be (e.g., may also be) associated with a RID rule that identifies a PDSI mapping algorithm that was (e.g., previously) configured in the UPF and identifies PDSI mapping algorithm parameters that are used to configure the identified algorithm. An example of PDSI mapping algorithm parameters may include the reset trigger and the base value. An example may include a PDSI step value that indicates how much a PDSI may be increased or decreased.

When the PDU set importance value is sent by the UPF to the RAN node in a GTP-U message, the UPF may include an indication in the GTP-U message that the UPF assigned a PDSI base value to the packet because a reset trigger was detected. The information (e.g., in the indication) may be used by the RAN to determine that the PDU set importance value cannot be used to infer the importance of the packet relative to earlier packets of the same QoS flow.

Relative importance may be identified by the UPF.

The SMF may configure the UPF with rules that are used by the UPF to determine what PDU set importance value are to be indicated to the RAN when the UPF sends a PDU set to the RAN. The indication may be sent from the UPF to the RAN in the header of the GTP-U message(s) that are used to send the PDU set to the RAN. The SMF may configure the UPF by sending a (e.g., N4) message to the UPF during a PDU session establishment or PDU session modification procedure.

The UPF may be configured with packet detection rules (PDRs) that are used by UPF to detect the format of the packet and assign a packet to a QoS flow. Detecting the format of the packet may mean that the UPF detects the type of media that is carried in the packet. In examples, the UPF may receive a PDR that includes an application ID that identifies an application detection rule. The application detection rule may be a rule that is used by the UPF to detect a certain media format. The PDR may be associated with a PDSI assignment rule. The PDSI assignment rule may be part of a QoS enforcement rule (QER). The PDSI assignment rule may be a rule that is used by the UPF to determine what PDU set importance value to assign to a PDU set.

A PDSI assignment rule may be associated with an application identifier (e.g., an application type). The application identifier may identify a protocol and media type combination (e.g. RTP H.265). The application identifier and/or the PDSI assignment rule may identify a relative importance determination (RID) rule. The RID rule may list the possible values of one or more header fields that are associated with the protocol and media type combination. The list may be presented in increasing or decreasing order to indicate to the UPF how to use the one or more header fields to determine the importance of the packet relative to other packets. For a header field that is associated with the protocol and media type combination, the list may indicate how much greater or less the assigned PDU set importance value is/should be relative to the PDU set importance of the previous PDU set. Different RID rules may be used concurrently, e.g., for different applications or flows.

A (e.g., each) PDSI assignment rule may include a PDSI base value. The base value may indicate a starting value for PDU set importance. In examples, the PDSI base value may be assigned to the first PDU set that the UPF receives that matches the protocol and media type combination that is identified by the application identifier. The UPF may assign a higher PDU set importance value to the next PDU set (e.g., a second PDU set) if the next PDU is more important than the first PDU set. The UPF may assign a lower PDU set importance value to the next PDU set if the next PDU is less important than the first PDU set. The UPF may assign the same PDU set importance value to the next PDU set if the next PDU is the same importance as the first PDU set. As described herein, the RID rule may be used to determine the importance of the next PDU set relative to the first PDU set.

When assigning a PDSI base value to a QoS flow/protocol/media type combination, the system (e.g., SMF) may configure the UPF(s) such that different QoS flows use different PDSI base values. Using different base values may allow the system to configure relatively higher base values for QoS flows or protocol/media format combinations that are relatively more important than other QoS flows or protocol/media format combinations.

A PDSI assignment rule may describe a PDSI reset trigger. The PDSI assignment rule may indicate to the UPF what event may (e.g., should) trigger the UPF to assign the PDSI base value to a PDU set.

In examples, the PDSI assignment rule may indicate a time value to the UPF. The time value may be the PDSI reset trigger, and the time value may indicate to the UPF that, if no PDU sets are received for the QoS flow within the time value, the UPF may (e.g., should) assign a PDSI value to the next PDU set has an equal PDSI base value. Enough time may have passed that it is unlikely that the RAN node is (e.g., still) buffering PDU sets for the QoS flow. There may be no value in indicating the PDU set importance relative to a PDU set that the RAN node has already transmitted.

In examples, the PDSI assignment rule may indicate an application ID (e.g., an application type) to the UPF. The application ID may be the PDSI reset trigger (e.g., the detection of the application ID may be used to determine that the PDSI assignment rule is to be applied). The application ID may point to, or identify, an application detection rule. If the UPF detects traffic that matches the application detection rules, the UPF may assign a PDSI value to the next PDU set that has an equal PDSI base value. A PDSI value may be assigned to the next PDU set that has an equal PDSI base value because the packet that matches the application detection rule is not be correlated with the packet that was previously sent (e.g. because a significant amount of time has passed since the previous pack was sent). The packet that matches the application detection rule may have no importance relative to the packet that was last received.

In examples, the PDSI assignment rule may indicate a protocol/media type/field value to the UPF. The protocol/media type/field value may include the PDSI reset trigger. If the UPF detects traffic that matches the identified protocol type and media payload type, the UPF may check if the identified field matches the value that was provided in the PDSI reset trigger. If there is a match, the UPF may assign a PDSI value to the next PDU set that has an equal PDSI base value. The packet that matches the combination may be representative of a packet that is not associated with (e.g., typically associated with), or correlated with, the packet that was previously sent. The packet that matches the combination may have no importance relative to the packet that was last received.

When the UPF determines to assign a PDU set importance value based on the reset trigger (e.g., decides to assign the PDSI base value), the UPF may indicate to the RAN node that the PDU set is being assigned the PDSI base value (e.g., because the UPF has determined that the PDU set is not associated with the previous PDU set (e.g., it is part of a new burst of data)). The indication may be sent to the RAN node in the GTP-U header with the PDU set importance value. If the UPF determines to assign the PDSI base value, the UPF may indicate (e.g., may also indicate) to the RAN node that the PDU set be considered lower in priority than the PDU set that was previously sent, higher in priority than the PDU set that was previously sent, or the same priority as the PDU set that was previously sent. The indication may be sent to the RAN node in the GTP-U header with the PDU set importance value.

In examples involving a RAN node, PDU importance may be used to determine what packets to drop during congestion.

When the RAN receives a PDU of a PDU set from the UPF, the PDU may be received in a GTP-U packet. The header of the GTP-U packet may indicate the PDU set importance value of the PDU set. The PDU set importance value may have been assigned by the UPF as described herein. In a congestion situation, the RAN may use the PDU set importance value to determine what PDU(s) to drop or discard in order to resolve congestion. Since the same PDU set importance value may be assigned to the (e.g., all) PDUs of a PDU set, the UPF may choose to include no PDU set importance in the GTP-U. The fact that there is not a PDU set importance value in the header may indicate that the PDU set importance value was indicated in the message that carried an earlier PDU of the same PDU set.

As described herein, the PDU set importance value may indicate to the RAN node the relative importance of a PDU relative to other PDU(s) of the same QoS flow. When the RAN determines what PDU(s) to drop, or discard in a congestion situation the RAN may select PDU(s) to drop from a (e.g., any) QoS flow. Priority level may be a parameter that is assigned to a (e.g., an entire) QoS flow and may indicate to the RAN the relative priority of a QoS flow to other QoS flow. As described herein, the parameter may indicate the importance of the QoS flow relative to other QoS flows and may not (e.g., in no way) account for the fact that the PDUs within a QoS flow may vary in importance.

As described herein, a discarding or dropping example where the RAN drops packets from the lowest priority flows may lead to a QoE decrease that is noticeable to the user.

During a PDU session establishment or PDU session modification procedure, the SMF may send the RAN node a discard factor for a QoS flow. The discard factor may be sent to the RAN node by the SMF via the AMF. The AMF may forward the message to the RAN node in an (e.g., N2) message. The discard factor of a (e.g., each) QoS flow may be included as part of the QoS profile of the PDU session. The discard factor may indicate to the RAN node what percentage of PDUs can be dropped from a QoS flow before it can be expected that the user notices a degradation in QoE. The RAN node may use the value to determine when to stop discarding packets from a first QoS flow and begin discarding packets from a second QoS flow which has been assigned a higher overall priority level.

In a downlink example associated with a RAN node, relative importance and a discard factor may be used to determine packet drop eligibility.

A WTRU may be configured with PDU set importance assignment rules and a discard factor. The WTRU upper layers may use the PDU set importance assignment rules to determine the importance of a PDU set relative to PDU sets that were (e.g., recently) sent from the WTRU upper layers to the WTRU lower layers. The WTRU Upper layers may determine a discard factor, and the WTRU lower layers may use the PDU set importance value and discard factor to determine what logical channel to assign the PDU set to.

A network node (e.g., a RAN node) may receive a discard factor from a network node (e.g., an SMF) in a message (e.g., an N2 message). The discard factor may be associated with a QoS flow and sent in a QoS profile. The RAN node may receive a downlink data packet (i.e., a PDU) and a PDU set importance value from a UPF in a GTP-U message. The RAN node may, in examples, use the discard factor and the PDU set importance value to determine transmission information. The RAN node may send a transmission in accordance with the determined transmission information. The transmission information may include what PDU(s) (e.g., at least one PDU) to drop or discard in order to resolve congestion (e.g., the transmission information may indicate to drop at least one PDU from multiple PDUs). The transmission may not include the at least one PDU (e.g., if the determined transmission indicates to drop the at least one PDU from the multiple PDUs.) The RAN node may, in examples, use the discard factor and the PDU set importance value to determine the transmission information (e.g., the transmission information may include what logical channel to assign the packet (e.g., the downlink PDU) to). The downlink PDU may be sent via the logical channel.

The discard factor may indicate to the RAN node what percentage of PDUs can be dropped from a QoS flow before it can be expected that the user will notice a degradation in QoE (e.g., the discard factor may indicate to the RAN node what percentage of PDUs can be dropped from a QoS flow based on a degradation threshold associated with the QoS flow being reached).

The discard factor may indicate to the RAN node that no packets (e.g., downlink PDUs) may be dropped from a QoS flow.

The (e.g., N2) message may indicate a (e.g., one) discard factor associated with a (e.g., each) PDU set importance value or a range/multiple PDU set importance values.

Discard factors (e.g., multiple discard factors) may be provided to the RAN node for a (e.g., each) QoS flow. There may be one discard factor associated with a (e.g., each) PDU set importance value or a (e.g., each) range of PDU set importance values. The RAN node may be configured, so that the RAN node will drop a relatively high percentage of low importance PDUs in a QoS flow and relatively low percentage of high importance PDUs in a QoS flow.

The discard factor may be important to convey to the RAN node because, without it, the RAN would be limited to using the priority level of the QoS flow when making discard decisions, and, as described herein, an example that relies on a priority level may result in a large percentage (e.g., too large of a percentage) of dropped packets from a (e.g., a single) QoS flow and cause a degradation in the QoE of the user. Examples described herein may enable a RAN configuration that will avoid discarding a large percentage (e.g., too large of a percentage) of dropped packets from a single QoS flow.

In order to spread dropping out more evenly over time, the discard factor may be presented as a percentage per unit of time.

The discard factor may be explicitly signaled to the PCF by the AF when the AF configured a QoS for a session. The AF may indicate the type of data in a flow, and the PCF may use the indication to determine the discard factor. The PCF may provide the discard factor to the SMF as part of the PCC rules.

An example of how the discard factor may be applied is as follows. During a period of congestion, the RAN may begin a process where PDUs are discarded. The RAN may begin dropping packets from the lowest priority QoS flow. When (e.g., each time) the RAN drops a packet from the QoS flow, the RAN may calculate the percentage of packets that were dropped from the QoS flow over a time period. The RAN may compare the calculated percentage against the discard factor of the QoS flow. If the percentage is lower than the discard factor, the RAN may continue to drop packets from the QoS flow until the congestion is resolved or until the calculated percentage is greater than or equal to the discard factor. When the result of the calculation is greater than or equal to the discard factor, the RAN may begin discarding packets from the QoS flow that is next highest in priority. The RAN may continue dropping PDUs from the QoS flow that is next highest in priority until the percentage of drop packets exceeds or is equal to the discard factor of the QoS flow that is next highest in priority. Once the percentage of drop packets exceeds or is equal to the discard factor of the QoS flow that is next highest in priority, the RAN will decide to begin dropping packets from a third QoS flow. The RAN may select the QoS flow that is next highest in priority, or the RAN may again choose the QoS flow that is lowest in priority (e.g., if enough time has passed to make the percentage of dropped packets from the first QoS flow lower than the discard factor of the first QoS flow).

Features described herein may be associated with an uplink handling of PDU set importance.

In the uplink, data may be sent from a WTRU application to an application server. The WTRU may use a PDU session to send the data to a UPF via a RAN node. The SMF may configure the WTRU, UPF, and RAN node with information that is used by the WTRU and RAN node to determine how to treat (e.g., prioritize) traffic of the PDU session. The following examples may describe how the SMF, WTRU, and RAN node can determine the importance of PDUs, assign an importance value to a PDU, and use the importance value to prioritize PDUs such that the user of the WTRU is less likely to notice a degradation in QoE when PDUs are prioritized and assigned to network resources (e.g. logical channels) by the WTRU.

At WTRU upper layer(s), relative importance may be identified, and relative importance information may be provided (e.g., conveyed) to WTRU lower layer(s).

A RAN node may be configured with a discard factor for a QoS flow. In some examples, the discard factor may be used so that the RAN node does not discard packets from the lowest priority QoS flows, and so that the RAN node can evenly spread out PDU set dropping events across QoS flows.

A WTRU (e.g., a WTRU upper layer) may receive a PDSI assignment rule from a network node (e.g., an SMF) in a message (e.g., a NAS message). The PDSI assignment rule may be associated with a QoS flow. The WTRU upper layer may receive an uplink data packet (e.g., a PDU) from an application associated with the WTRU (e.g., a WTRU application). The WTRU upper layer may use the PDSI assignment rule and one or more of a PDSI base value or the PDU set importance of a previous uplink data packet to determine a PDU set importance value associated with the PDU. The WTRU upper layer may use the PDSI assignment rule to determine a discard factor associated with the uplink data packet (e.g., for the uplink data packet). The WTRU upper layer may send the PDU, the determined PDU set importance value, and the discard factor (e.g., to lower layer(s) of the WTRU), and the WTRU lower layers may use the PDU set importance value and the discard factor to determine what logical channel to assign the PDU set, so that the lower layers can assign PDUs from the same QoS flow to different logical channels (e.g., the WTRU may send PDUs associated with the QoS flow in accordance with the PDU set value and the discard factor). In examples, the WTRU may determine a first logical channel for a first PDU of the PDUs based on the PDU set value and the discard factor. In examples, the WTRU may determine a second logical channel for a second PDU of the PDUs based on the PDU set value and the discard factor. The WTRU may send the first PDU on the first logical channel and the second PDU on the second logical channel.

The WTRU upper layer may be the SDAP layer, the NAS layer, or a combination of the SDAP and NAS layers.

The message (e.g., NAS message) may be a PDU session establishment accept message or a PDU session modification message (e.g., a PDU session modification command message).

The PDSI assignment rule may be part of a QoS rule.

The PDSI assignment rule may be associated with an application identifier. The application identifier may be used to determine that the PDSI assignment rule is to be applied. The application identifier may be used to determine what relative importance determination (RID) rule to use to determine the PDU set importance value to assign to the uplink data packet.

The PDSI assignment rule may be associated with a PDSI base value that indicates a starting value for PDU set importance.

The PDSI assignment rule may be associated with a PDSI reset trigger that indicates a condition that triggers) the WTRU upper layer to assign the PDSI base value as the PDU set importance value of the uplink data packet.

The reset trigger may indicate a time value, and if the duration between receiving or sending PDU sets for the same QoS flow exceeds the time value, the WTRU may be triggered to assign the PDSI base value as the PDU set importance value of the next uplink data packet.

The reset trigger may indicate an application ID, and when the WTRU detects that the uplink packet matches the application detection rule that is identified by the application ID, the UPF may be triggered to assign the PDSI base value as the PDU set importance value of the uplink data packet.

The reset trigger may indicate a protocol/media type/field value combination. When the WTRU detects that the uplink packet matches the combination, the WTRU may be triggered to assign the PDSI base value as the PDU set importance value of the uplink data packet.

The WTRU upper layer may receive a mapping table that indicates that at least one URL is associated with at least one application ID. The WTRU upper layer may determine to use the URL to download an application detection rule that is associated with the application ID, and the WTRU upper layer may use the application detection rule to determine if the PDSI assignment rule may (e.g., should) be applied to an uplink data packet.

When the PDU set importance value is sent by the SDAP layer to the lower layers, the SDAP layer may include an indication in the message that the WTRU upper layers assigned a PDSI base value to the packet because a reset trigger was detected. The information (e.g., the information in the indication) may be used by the WTRU lower layers to determine that the PDU set importance value cannot be used to infer the importance of the packet relative to earlier packets of the same QoS flow.

The SMF may configure the WTRU with rules that are used by the WTRU to determine what PDU set importance value may (e.g., should) be indicated by the SDAP layer to the lower layers when the SDAP layer sends a PDU to the lower layers. The SMF may configure the WTRU by sending a NAS message to the WTRU during a PDU session establishment or PDU session modification procedure. In examples, the configuration information may be sent an PDU session establishment accept message or a PDU session modification command message.

The QoS rules that are sent to the WTRU may be modified to include application ID(s) that identify an application detection rule. The application detection rule may be a rule that is used by the WTRU to detect a certain media format. When the WTRU upper layer determines that a packet of application traffic matches the application detection rule, the WTRU may assign the packet to a QoS flow. The QoS rule may be associated with a PDSI assignment rule. The PDSI assignment rule may be part of a QoS rule. Similar to examples described herein (e.g., for the UPF), the PDSI assignment rule may be a rule that is used by the WTRU to determine what PDU set importance value to assign to a PDU set. As described herein, the PDSI assignment rules may include application identifier(s), PDSI base value(s), and PDSI reset triggers. The application identifier may further identify a relative importance determination (RID) rule. The QoS rule may be associated with a WTRU discard factor. The WTRU discard factor may be part of a QoS rule. Similar to an example described herein (e.g., for the RAN node), the WTRU discard factor may indicate to the WTRU what percentage of PDUs can be dropped from a QoS flow before it can be expected that the user will notice a degradation in QoE. The PDSI assignment rule may describe how to detect the traffic that the rule applies to (e.g. use the application detection rule that is identified by the application identifier), indicate how to inspect the traffic deeply (e.g. look at the header), and determine the PDU set importance value (e.g. use a header value and the PDU set importance value that was assigned to the previous packet).

The discard factor that is configured in the RAN and is described above may be called a RAN discard factor or a downlink discard factor. As described above, the RAN discard factors are configured in the RAN by the SMF in the QoS profile.

The discard factor that is configured in the WTRU and is described herein may be called a WTRU discard factor or an Uplink discard factor. As described herein, the WTRU discard factors may be configured in the WTRU by the SMF in the QoS rules.

The SMF may determine the WTRU discard factors and the RAN Discards Factors based on PCC rules or an explicit indication from the PCF. The information from the PCF may be based on information from the AF (e.g. discard factors or traffic type information from the AF).

The SMF may choose to send different discard factors to the WTRU and RAN for QoS flows that are associated with the same IP 4-tuples. In examples, downlink traffic may be more important than uplink traffic.

The application detection rule that is identified by the application ID may be configured in the WTRU. The information may be configured in the WTRU in a NAS message. In an example, the information may be configured in the WTRU, and the PCF may send the WTRU a list of application ID(s) and a URL that is associated with an (e.g., each) application ID. The URL may be used by an application layer of the WTRU to contact a server and download the application detection rule from the server. The WTRU application may subscribe to the server to receive updated versions of the application detection rule from the server. The list of application ID(s) and associated URL(s) may be called a WTRU application ID mapping table.

The WTRU application ID mapping table may include the application detection rule instead of the URL that is used to download the application detection rule. When including the application detection rule instead of the URL, the WTRU may not use (e.g., may not need to use) a WTRU application to download the application detection rule over the user plane. When including the URL in the WTRU application ID mapping table, application detection rules (which may be relatively large) may not be (e.g., may not need to be) sent in a message (e.g., a NAS) message and may be downloaded and updated (e.g., on an as-needed basis).

An application layer may provide an application layer packet to the WTRU upper layers, and the WTRU upper layers may use the QoS rules to assign the packet to a QoS flow and may use the PDSI assignment rule to determine a PDU set importance value for a (e.g., each) PDU. The PDU set importance value may be assigned as described herein. If the WTRU upper layer detects traffic that matches the identified protocol type and media payload type, the WTRU upper layer may check if the identified field matches the value that was provided in the PDSI reset trigger. If there is a match, then the UPF may assign a PDSI value to the next PDU set that is an equal PDSI base value. The packet that matches the combination may be representative of a packet that is not associated with (e.g., not typically associated with), or correlated with, the packet that was previously sent. The packet that matches the combination may have no importance relative to the packet that was last received. The WTRU Upper layer may assign the PDSI base value to the first PDU set that the WTRU upper layer receives from an application that matches the protocol and media type combination that is identified by the application identifier. The WTRU upper layer may assign a higher PDU set importance value to the next PDU set if the next PDU is more important than the first PDU set. The WTRU upper layer may assign a lower PDU set importance value to the next PDU set if the next PDU set is less important than the first PDU set. The WTRU upper layer may assign the same PDU set importance value to the next PDU set if the next PDU is the same importance as the first PDU set. As described herein, the RID rule may be used by the WTRU upper layer to determine the importance of the next PDU set relative to the first PDU set.

The SDAP layer may send to the PDU the determined PDU set importance value and the discard factor to the WTRU lower layers. The WTRU lower layers may use the PDU set importance value and discard factor to determine what logical channel to assign the PDU set to (e.g., instead of assigning (e.g., all) the PDUs from one DRB to the same logical channel). In examples, the packets that are important (e.g., more important) may be assigned to logical channels that are configured to be important (e.g., more important) and may be prioritized in terms of allocating network resources. In examples, packets that are associated with a larger discard factor may be allocated to a logical channel that is allocated relatively less network resources.

When the SDAP layers sends the lower layer a PDU set importance value that is based on the reset trigger (e.g., the upper layers decide to assign the PDSI base value), the SDAP layer may indicate to the lower layers that the PDU set is being assigned the PDSI base value because the WTRU upper layers have determined that the PDU set is not associated with the previous PDU set (e.g., the PDU set is part of a new burst of data). The indication may be sent to the lower layers with the PDU set importance value. As described herein, data sent to a particular layer (e.g., a higher layer/a lower layer) may be indicative of sending data to a device irrespective of a layer (e.g., sending data to a network node, a WTRU, a base station, a network, etc.).

A WTRU, UPF, and RAN node of a PDU session may be configured (e.g., by an SMF) to deal with relative importance (e.g., for uplink and downlink).

In order to configure a PDU session, an SMF may send a first PDSI assignment rule to a WTRU in a NAS message. The PDSI assignment rule may be associated with a QoS flow. The PDSI assignment rule may include a PDSI base value and a discard factor. The SMF may send a second PDSI assignment rule to a UPF in a message (e.g., an N4 message). The PDSI assignment rule may be associated with a QoS flow and may include a PDSI base value. The SMF may send a discard factor to a RAN node in a message (e.g., an N2 message). The discard factor may be associated with a QoS flow and may be sent in a QoS profile.

A network node (e.g., an SMF) may detect a triggering event. The SMF may send a first PDSI assignment rule to a WTRU in a message (e.g., a NAS message). The PDSI assignment rule may be associated with a QoS flow. The PDSI assignment rule may include a PDSI base value and a discard factor. An SMF may send a second PDSI assignment rule to a network node (e.g., a UPF) in a message (e.g., an N4 message). The PDSI assignment rule may be associated with a QoS flow and may include a PDSI base value. An SMF may send a discard factor to a RAN node in a message (e.g., an N2 message). The discard factor may be associated with a QoS flow and may be sent in a QoS profile.

One or more of the first PDSI assignment rules or the second PDSI assignment rules may include a PDSI reset trigger. The PDSI reset trigger may indicate a condition that may trigger the WTRU or UPF to assign the PDSI base value as the PDU set importance value of a data packet. In examples, the PDU set importance reset trigger may indicate a condition, and the SMF may, based on the condition being satisfied, assign the first PDU set importance base value as the PDU set value of a downlink PDU. In examples, based on the condition being satisfied, the SMF may assign the second PDU set importance base value as the PDU set importance value of a downlink PDU.

The reset trigger may indicate a time value, an application ID, or a protocol/media type/field value combination, and when the combination is detected in the downlink packet, the WTRU or UPF may be triggered to assign the PDSI base value as the PDU set importance value of the data packet.

The reset trigger may indicate a time value, and when the duration between receiving or sending PDU sets for the same QoS flow exceeds the time value, the WTRU or UPF may be triggered to assign the PDSI base value as the PDU set importance value of the next data packet.

The reset trigger may indicate an application ID, and when the WTRU detects that the uplink packet matches the application detection rule that is identified by the application ID, the WTRU or UPF may be triggered to assign the PDSI base value as the PDU set importance value of the data packet.

The reset trigger may indicate a protocol/media type/field value combination, and when the WTRU or UPF detects that the uplink packet matches the combination, the WTRU or UPF may be triggered to assign the PDSI base value as the PDU set importance value of the data packet.

The NAS message may be a PDU session establishment accept message or a PDU session modification message.

The first PDSI assignment rule may be part of a QoS rule.

The NAS message may include a mapping table that indicates that at least one URL is associated with at least one application ID.

The triggering event may be reception of a PDU session establishment request from the WTRU, reception of a PDU session modification request from the WTRU, or reception of updated PCC rules from a PCF.

PDU set importance may be handled in a PDU session.

### Haptics Data

Haptics provides multimedia application users (also referred to herein as users or end users) with additional sensory effects in addition to audio and video, allowing them to experience sensory immersion. Users can enjoy existing media more abundantly through haptics effects. In this regard, some media container formats, such as ISO based media file format (ISOBMFF), define haptics as one of the supported primary media types, along with the other existing primary media types, such as audio, and video. The ISO/IEC 23090-31 specification defines the data format, metadata, and codec architecture for haptics signals. Haptics data may be transmitted to devices that act as actuators and provide information for actuators to operate according to the values contained in the haptics data.

Haptics refers to the sense of touch and is generally divided into two (or three) distinct channels of sensory experience: kinesthetic, cutaneous, and proprioception. Kinesthetic experience includes kinesthesia, which refers to the sensation of positions, velocities, forces and constraints, that arises from the muscle spindles and tendons. It is related to force feedback devices or pseudo-haptic feedback (pulse oscillations). Specialized cells for kinesthetic haptics may include mechanoreceptors, muscles spindles and tendons and such haptics may involve force feedback devices, robotic arms, skeletons, or the like.

Cutaneous experience includes tactile experience. Specialized cells for cutaneous haptics may include mechanoreceptors and thermoreceptors. Cutaneous haptics may be provided as thermal experiences (e.g., Peltier or heat elements), texture experience (e.g., via a pin array, piezoelectric elements, a vibratory pin array, and/or an electrode array), vibration/contact experiences (e.g., via one or more soleniods, piezoelectric elements, motors with eccentric mass, and/or audio speakers), pressure experiences (e.g., via an airjet, ultrasound, and/or smart metal), or a combination thereof.

Proprioception may be considered as part of the kinesthetic sensation or as a separate channel of experience as proprioception relates to motion. Proprioception includes motion, linked to the vestibular system, and motion simulation. Motion is the sense of the relative position of neighboring parts of the body and strength of effort employed in movement. Proprioception is linked to the vestibular system, but also includes muscles spindles, tendons (especially the Golgi tendon organ) and joints. Motion simulation may include motion platforms and vestibular stimulations.

MIHS (MPEG-I Haptic Streaming) is a streaming format used to transport haptics data. Haptics data, which includes haptic effects, are packetized based on the MIHS format, and delivered to actuators that operate according to the haptics effects. MIHS has two levels of packetization, which are MIHS units and MIHS packets.

MIHS units include a MIHS unit header and zero or more MIHS packets. MIHS units can belong to one of four types. An initialization MIHS unit sets a timestamp and can include one or more MIHS packets. A temporal MIHS unit contains data defining time-dependent effects and supports modalities such as, for example, pressure, velocity, and acceleration. A spatial MIHS unit contains time independent haptic effects and supports modalities such as vibrotactile texture, stiffness, and friction. Temporal and spatial MIHS units may include one or more MIHS packets. Silent MIHS units are transmitted when there is no haptic data to transmit and contain no MIHS packets.

A temporal MIHS unit may be a sync unit or a non-sync unit. A non-sync MIHS unit depends on the most recent sync MIHS unit for decoding. Initialization MIHS units are transmitted regularly to allow for random access as these units are essential to decode the haptics stream.

The following terms are defined by the MIHS standard: a MIHS format, a MIHS packet, a MIHS unit, an initialization unit, a temporal unit, a spatial unit, a silent unit, and a MIHS Layer.

The MIHS format is a self-contained stream format for transporting MPEG-I haptic data. The MIHS packet is a unit of haptics data which includes metadata or binary effect data.

The MIHS unit is a unit of haptics data that includes metadata and/or haptic effect data. The haptics data format is divided into a MIHS unit and a packet, and the MIHS unit has four kinds of types: initialization, temporal, spatial, and silent.

The initialization unit is a type of MIHS unit containing metadata necessary to reset and initialize a haptic decoder. The temporal unit contains one or more MIHS packets. The duration of a temporal unit is a positive number. The spatial unit contains one or more MIHS packets. The duration of a spatial unit is zero. The silent unit indicates that there is no effect that starts during the associated time interval and does not include any MIHS packets. The duration of a silent unit is a positive number.

The MIHS layer is a numerical parameter associated with a MIHS packet, which may be used to represent the importance of the packet for scalability.

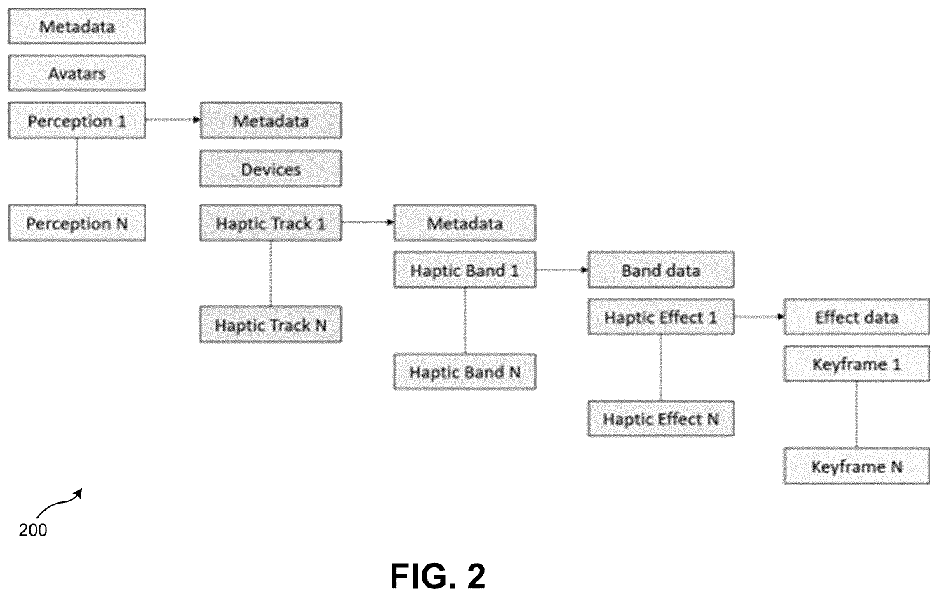

FIG. 2 is a flowchart illustrating a hierarchical organization 200 of a data structure of a MPEG haptic media format. The format contains high-level metadata information regarding the overall haptic experience defined in the file. The format also provides a list of avatars (i.e., body representations) referenced in the file to specify the desired location of haptic stimuli on the body. The haptic data itself is described through a list of perceptions. These perceptions correspond to haptic signals associated with specific perception modalities (i.e., vibration, force, position, velocity, temperature, and the like).

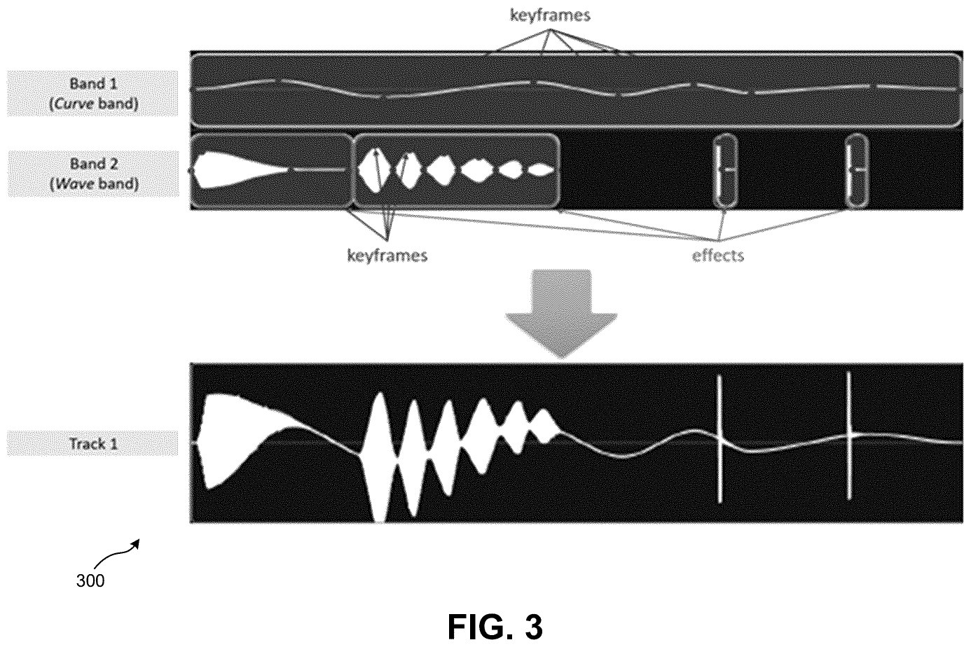

A perception contains a list of tracks where the data is decomposed in frequency bands. Each band defines part of the signal in a given frequency range. The band itself is described with a list of haptic effects, each containing a list of keyframes. The haptic signal in a track can be reconstructed by combining the data in the different bands. FIG. 3 is a diagram illustrating how a haptic signal can be decomposed in two frequency bands (e.g., Band 1 and Band 2). By adding the high and low frequency bands, the original signal can be reconstructed.

The format proposes four types of haptic bands: transient bands, curve bands, vectorial wave bands and wavelet bands. Each band is composed of a series of “effects” each defined by a list of “keyframes.” The data contained in the effects and keyframes is interpreted differently for different types of haptic bands and encoding modalities.

For a transient band, each effect stores a set of keyframes defining a position, an amplitude, and a frequency. A keyframe represents a transient event.

For a curve band, each effect stores a set of keyframes defining a position and an amplitude. The keyframes represent the control points of the curve. The type of interpolation function (e.g., cubic or linear) used to generate the band is specified in the metadata of the band.

For vectorial wave bands, the effect stores a set of keyframes defining a position, an amplitude, and a frequency.

For wavelet bands, the effect stores the contents of one wavelet block and contains a keyframe for every coefficient of the wavelet transformed and quantized signal, with only the amplitude value used. The coefficients are scaled to a range of [−1,1]. Additionally, the original maximum amplitude is stored in a keyframe, as well as the maximum number of used bits.

FIG. 3 is a diagram illustrating a comparison 300 of a haptic signal (bottom) and a decomposition of the haptic signal in two frequency bands (top).

RTP (Real-time Transport Protocol) is a standard protocol for transmitting real-time voice, video, and data over an IP network. RTP is defined in IETF RFC 3350. RTP uses RTCP (Real-time Control Protocol) to monitor data transfer status, provide minimum control functions, and media identification. RTP is used in telecommunications and entertainment systems involving streaming media, such as telephony, WebRTC, television services, and video telephony including web-based push-to-talk capabilities. However, the value of utilization increases only when a separate payload is configured according to the video codec. To this end, several RTP payload standards adapted to the characteristics of specific codecs have been established to enable transmission of audio and video encoded with various codecs in RTP.

The RTP payload format for the transport of MPEG-I haptic data has been defined in an IETF draft entitled “RTP Payload for Haptics,” published Jan. 4, 2025 by the avtcore workgroup. The RTP payload header format allows for packetization of MIHS units in an RTP packet payload as well as fragmentation of a MIHS unit into multiple RTP packets.

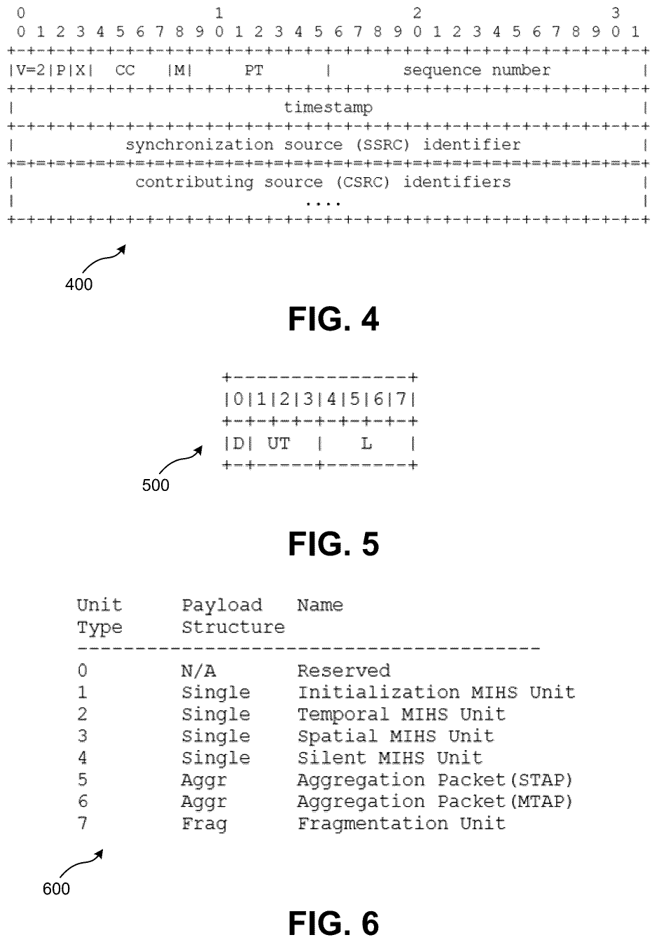

FIG. 4 is a diagram illustrating a RTP header 400 as defined in IETF RFC3550. Some of the header field values are interpreted as follows:
Payload type (PT): 7 bits. The assignment of a payload type is performed either through the profile used or in a dynamic way.
Time Stamp (TS): 32 bits. A timestamp representing the sampling time of the first sample of the MIHS unit in the RTP payload. The clock frequency is set to the sample rate of the encoded haptic data and is conveyed out-of-band (e.g., as an SDP parameter).
Marker bit (M): 1 bit. The marker bit should be set to one in the first non-silent RTP packet after a period of haptic silence. This enables jitter buffer adaptation and haptics device washout (i.e., reset to a neutral position) prior to the beginning of the burst with minimal impact on the quality of experience for the end user. The marker bit in all other packets is set to zero.

The RTP Payload Header of a haptics media RTP packet follows the RTP header 400 shown in FIG. 4. As described in the IETF draft “RTP Payload for Haptics,”, FIG. 5 is a diagram illustrating a RTP Payload Header 500 for haptics media. Some of the header field values are interpreted as follows.
D (Dependency, 1 bit): This field is used to indicate whether the MIHS unit included in the RTP payload is, when its value is one, dependent or, when its value is zero, independent.
UT (Unit Type, 3 bits): This field indicates the type of the MIHS unit included in the RTP payload. FIG. 6 is a diagram illustrating a list 600 of unit type values.
L (MIHS Layer, 4 bits): This field is an integer value that indicates the priority order of the MIHS unit included in the RTP payload, as determined by the haptic sender (e.g., by the haptic codec), based on application-specific needs. For example, the sender may use the MIHS layer to prioritize perceptions with the largest impact on the end-user experience. Zero corresponds to the highest priority. The semantic of individual MIHS layers is not specified and left for the application to assign.

The RTP header extension may provide at least the following information: 1) PDU Set sequence number, 2) Sequence number of PDU within the PDU Set, 3) Boundaries of the PDU set (i.e., End of PDU Set marking), 4) PDU Set importance, 5) Size in bytes of a PDU Set, and 6) Number of PDUs in a PDU set.

The header extension includes fields that may be used to derive information, such as, for example, PDU Set Sequence Number, Indication of End PDU of the PDU Set, PDU Sequence Number within a PDU Set, PDU Set Importance and an optional PDU Set Size (e.g., in bytes) and the number of PDUs in a PDU Set. The defined header extensions includes fields that carry an extensions element identifier, an End Flag that indicates that the PDU is the last PDU of a PDU set, a flag that indicates that the PDU may be discarded without significant impact to the reconstructed media, a field that indicates priority, a sequence number of the PDU set, the number of PDUs in the PDU set, a sequence number of the PDU, and a PDU Set Size that indicates the size in bytes of all PDUs of the PDU set.

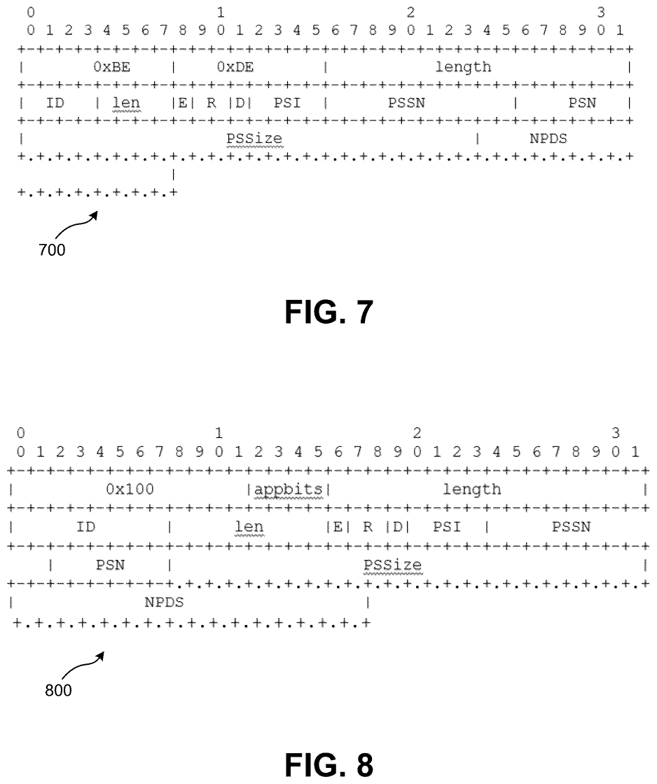

The RTP Header Extension for PDU Set Marking may be formatted as a single byte or two bytes. FIG. 7 is a diagram illustrating a one-byte RTP HE 700 for the marking of PDU Sets and End of Bursts. FIG. 8 is a diagram illustrating a two-byte RTP HE 800 for the marking of PDU Sets and End of Bursts.

In general, whenever the radio area network (RAN) needs to discard packets (e.g., under congestion situations), it is better to discard packets of lower importance rather than discarding packets randomly. When a discarded packet is critical for the media stream, the QoE may be severely degraded. For this reason, the PDU Set Importance (PSI) field may be used to mark PDU sets with their importance level. The PSI field may then be used by the RAN to discard PDU sets. In case of congestion, PDU sets with higher PSI values are more likely to be discarded.

The assignment of values for various fields present in the PDU set marking header extension for audio and video media streams have been specified in TS 26.322.

During a streaming PDU session, when the congestion in RAN happens, the transmission of the more important data (e.g., an I frame) may be prioritized and the RAN may drop the less important data (e.g., a B frame) to the user equipment. During the congestion period, the continuous less importance data from the user plane function (UPF) to the RAN may cause the RAN to be more congested and waste the transport layer resource between the RAN and the UPF. The UPF may also drop some less important data to the RAN when RAN is congested. To enable the differentiated PDU Set handling, SA2 has defined the concept of PDU set importance and to enable the PDU set handling within a QoS flow where the PDU set information has been defined in SA2. The PDU Set information can be provided to UPF and RAN from the application server (AS) in a PDU Set Marking RTP HE. When the PDU Set Marking RTP HE is not available, UPF can derive the PDU set information by performing deep packet inspection of the RTP header.

The 5G Real-time Media Transport Protocol Configurations specification TS 26.322 specifies setting the fields present in the PDU Set Marking RTP HE for audio and video data. The TS 26.322 specification also specifies, for the UPF network function, on how to obtain the PDU set information from RTP payload for audio and video data when the PDU Set Marking RTP HE is not present in the PDUs.

This disclosure defines how to set the PDU Set Marking RTP HE fields for haptics media streams. This disclosure describes the ways to signal the PDU set information RTP header extension details of the haptics media stream to the UPF and the differentiated handling of multiplexed media streams containing haptics media streams, audio, video and any other media streams. Also, this disclosure describes how the UPF obtains the PDU set information from RTP payload for haptics media data when the PDU Set Marking RTP HE is not present in the PDUs.

To enable differentiated PDU set handling and PDU set handling within a QoS flow, the 3GPP SA2 working group has defined the concept of PDU set information and the PDU set importance. This disclosure describes how to set the PDU Set Importance (PSI) field in the PDU Set Marking RTP HE for haptics media streams. This disclosure also describes the ways to signal the PDU set information RTP header extension details of a haptics media stream to the UPF.

Examples described herein mark marking the PSI field in an PDU Set Marking RTP HE based on haptic media characteristics. The haptic media characteristics may include a MIHS unit type, a dependent MIS unit, a MIHS unit Layer information, or a combination thereof. Examples described herein also provide control plane signaling to UPF for identifying the haptics media data and it's PDU set information using the media type, payload type and the RTP HE ID parameters.

### Dependent MIHS Units

The RTP Payload Header for haptics media was described and illustrated in FIG. 5. As described above, in haptics media RTP packets, MIHS units with the dependency field in the RTP payload header set to the value 0 (refer to FIG. 5) are independently decodable by the haptics media decoder. The independent MIHS units do not depend on other dependent or independent MIHS units during the decoding process.

PDU sets that contain independent MIHS units are more important compared to PDU sets that contain dependent MIHS units. Therefore, PDU sets that contain independently decodable MIHS units in the haptics media RTP packets/PDUs are assigned a lower PSI value compared with PDU sets that contain dependent MIHS units.

When the dependency field value in the RTP payload header of an RTP packet is 0, the corresponding PDUs in that PDU set are set with higher importance or with a lower PSI value.

When the dependency field value in the RTP payload header of an RTP packet is 1, the corresponding PDUs in that PDU set are set with lower importance or a higher PSI value compared with the Haptics media RTP packets with a dependency field value of 0.

An RTP sender sets the PSI field value present in the PDU Set Marking RTP HE for a dependent and independent MIHS unit based on the above logic.

When the UPF receives the PDUs from the RTP sender and the PDU Set Marking RTP HE is not available in the PDUs it received, the UPF inspects the RTP packet and finds the dependency field in the RTP payload header.

When the dependency field value in the RTP payload header of an RTP packet is 0, the corresponding PDUs in that PDU set are set with higher importance or with a lower PSI value.

When the dependency field value in the RTP payload header of an RTP packet is 1, the corresponding PDUs in that PDU set are set with lower importance or a higher PSI value compared with the haptics media RTP packets with a dependency field value of 0.

### MIHS Unit Type

The following sections describe how the PDU Set Importance field is set for a PDU carrying haptics media content based on the MIHS unit type.

a. Initialization MIHS Units

An initialization MIHS unit contains MIHS packets carrying metadata necessary to reset and initialize a haptic decoder, including a timestamp. So, initialization MIHS units are very important to configure the decoder at the beginning of the decoding process. In a haptic media RTP packet containing the initialization MIHS units, the unit type field of the RTP payload header is set with value 1 as described in IETF draft “RTP Payload for Haptics.”

PDUs or PDU sets that contain the initialization MIHS units are assigned a higher importance or lower PSI value compared with PDU sets that contain non-initialization MIHS units. Such PDUs or PDU sets are assigned, for example, a PSI value in the range 6-8 (inclusive).

An RTP sender sets the PSI field value present in the PDU Set Marking RTP HE for an initialization MIHS unit based on the above logic.

When the UPF receives the PDUs from the RTP sender and the PDU Set Marking RTP HE is not available in the PDUs it received, the UPF inspects the RTP packet and finds the unit type field in the RTP payload header.

b. Spatial MIHS Units

A spatial MIHS unit may contain one or more MIHS packets providing time-independent effects, such as, for example, vibrotactile texture, stiffness, and friction. The duration of a spatial unit is zero. The spatial MIHS packets present in a haptics media RTP packets/PDUs are independently decodable by a haptics media decoder. Hence, the spatial MIHS units present in a PDU set is delivered with higher priority. In a haptic media RTP packet containing the spatial MIHS units, the unit type field of the RTP payload header is set with value (e.g., 3) as described in the IETF draft “RTP Payload for Haptics.”

PDUs or PDU sets that contain the spatial MIHS units are assigned a higher importance or lower PSI value compared to PDU sets that contain dependent temporal MIHS units. The PSI value for the PDUs or PDU sets that contain spatial MIHS units are set equal to or slightly higher than the PSI value of the PDUs or PDU sets that contain initialization MIHS units. For example, PDUs or PDU sets containing spatial MIHS units are assigned a PSI value in the range 9-11 (inclusive).

An RTP sender sets the PSI field value present in the PDU Set Marking RTP HE for a spatial MIHS unit based on the above logic.

When the UPF receives the PDUs from the RTP sender and the PDU Set Marking RTP HE is not available in the PDUs it received, the UPF inspects the RTP packet and finds the unit type field in the RTP payload header. When the unit type field has a predetermined value associated with spatial units (e.g., 3), the UPF assigns the PSI value for those PDUs based on the above logic for spatial MIHS units.

c. Temporal MIHS Units

A temporal MIHS unit may contain one or more MIHS packets defining time-dependent effects and providing modalities, such as, for example, pressure, velocity, and acceleration. The duration of a temporal unit is a positive number. Temporal MIHS units can be dependent or independent units. Independent temporal MIHS units can be decoded independently using a haptics media decoder. Whereas a dependent temporal MIHS unit is the continuation of previous MIHS units and cannot be independently decoded and rendered without having decoded previous MIHS unit(s).

In a haptic media RTP packet containing the temporal MIHS units, the unit type field of the RTP payload header is set with a value of 2. When the temporal MIHS unit is independently decodable, then the dependency field value in the RTP payload header of such haptics media RTP packet is set to a value of 0. When the temporal MIHS unit is not independently decodable, then the dependency field value in the RTP payload header of such haptics media RTP packet is set to 1 as described in IETF draft “RTP Payload for Haptics.”

PDUs or PDU sets that contain the independent temporal MIHS units are assigned a higher importance or lower PSI value compared to the PDUs or PDU sets that contain dependent temporal MIHS units. The PSI value for the PDUs or PDU sets that contain independent temporal MIHS units are set equal to the PSI value of the PDUs or PDU sets that contain spatial MIHS units. The PSI value for the PDUs or PDU sets that contain dependent temporal MIHS units are set higher than the PSI value of the PDUs or PDU sets that contain initialization, spatial, and/or independent temporal MIHS units.

An RTP sender sets the PSI field value present in the PDU Set Marking RTP HE for a temporal MIHS unit based on the above logic.

When the UPF receives the PDUs from the RTP sender and the PDU Set Marking RTP HE is not available in the PDUs it received, the UPF inspects the RTP packet and finds the unit type field in the RTP payload header. When the unit type field has a predetermined value associated with temporal units (e.g., 2), the UPF assigns the PSI value for those PDUs based on the above logic for temporal MIHS units.

d. Silent MIHS Units

A silent MIHS unit indicates that there is no effect during a time interval and its duration is a positive number. A sender may decide not to send silent units, to save network resources. Since, from a receiver standpoint, a missed MIHS unit may originate from a not-sent silent unit, or a lost packet, a sender may send one, or a few, MIHS silent units at the beginning of a haptic silence.

The silent packets are of less importance relative to other packets as they are transmitted to the receiver to indicate that there is no haptic effect during a period of time.

Accordingly, PDUs or PDU sets that contain the silent MIHS units are assigned lower importance or higher PSI value compared to the PDUs or PDU sets that contain non-silent MIHS units. The PSI value for silent MIHS packets can be, for example, 15, as these packets are less important relative to other MIHS packets. The first few MIHS silence units at the beginning of a haptic silence may be set with slightly higher priority compared to other silent MIHS packets (e.g., set with a PSI value of 13 or 14) as these packets are required at the receiver to know that there is a haptic silence after this MIHS silent packet.

An RTP sender sets the PSI field value present in the PDU Set Marking RTP HE for a silent MIHS unit based on the above logic.

When the UPF receives the PDUs from the RTP sender and the PDU Set Marking RTP HE is not available in the PDUs it received, the UPF inspects the RTP packet and finds the unit type field in the RTP payload header. When the unit type field value is set to a predetermined value associated with silent units (e.g., 4), the UPF assigns the PSI value for those PDUs based on the above logic.

e. Fragmentation Unit

Three different types of RTP packet payload structures are specified for transmitting haptics media data. A single unit packet contains a single MIHS unit in the payload. A fragmentation unit contains a subset of a MIHS unit as described in the IETF draft “RTP Payload for Haptics.” An aggregation packet contains multiple MIHS units in the payload.

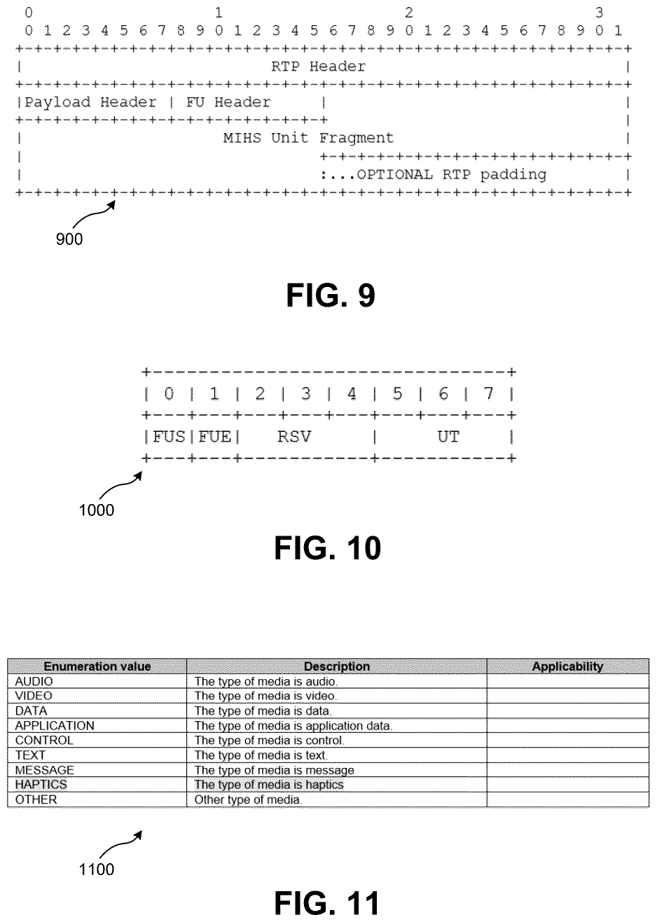

As described in the IETF draft “RTP Payload for Haptics,” a fragmented unit payload structure in an RTP packet contains the RTP header, followed by the payload header, a fragmented unit (FU) header, and an MIHS unit fragment. FIG. 9 is a diagram illustrating a fragmented unit payload structure 900 in an RTP packet according the IETF draft “RTP Payload for Haptics.” The value of the unit type field of the payload header is 7. FIG. 10 is a diagram illustrating a structure 1000 of the FU header.

The MIHS unit type of a RTP packet containing the fragmented MIHS unit haptic media is identified using the unit type field present in the FU header. PDUs or PDU sets that contain the initialization MIHS unit in a fragmented RTP packet are assigned a PSI value as specified above with respect to the initialization MIHS unit. PDUs or PDU sets that contain the spatial MIHS unit in a fragmented RTP packet are assigned a PSI value as specified above with respect to the spatial MIHS unit. PDUs or PDU sets that contain the temporal MIHS unit in a fragmented RTP packet are assigned a PSI value as specified above with respect to the temporal MIHS unit.

An RTP sender sets the PSI field value present in the PDU Set Marking RTP HE for a fragmentation unit based on the above logic.

When the UPF receives the PDUs from the RTP sender and the PDU set Marking RTP HE is not available in the PDUs it received, the UPF inspects the RTP packet and finds the unit type field in the FU header. When the unit type field (present in the RTP header) value is 7, the UPF assigns the PSI value for those PDUs based on the unit type field (present in the FU header) value using the above logic.

### f. MIHS Layer

The MIHS layer field present in the RTP payload header of a haptic RTP packet indicates the priority order of the MIHS unit included in the RTP payload, as determined by the haptic sender (e.g., by the haptic codec), based on, for example, application-specific needs. For example, the sender may use the MIHS layer to prioritize perceptions with the largest impact on the end-user experience. The value zero for the MIHS layer field corresponds to the highest priority.

When the MIHS layer field value in the RTP payload header of an RTP packet is zero, then the corresponding PDUs in that PDU set is set with higher importance or with a lower PSI value compared to the PDUs or PDU sets with a MIHS layer field value greater than zero. When a list of PDUs or PDU Sets contain the same MIHS layer field value in the RTP payload header, the PSI value of such PDUs or PDU sets are set based on the dependency field and the unit type field values present in the RTP payload header.

An RTP sender sets the PSI field value present in the PDU Set Marking RTP HE for MIHS units belonging to a specific MIHS layer based on the above logic.

When the UPF receives the PDUs from the RTP sender and the PDU Set Marking RTP HE is not available in the PDUs it received, the UPF inspects the RTP packet and finds the MIHS layer field present in the RTP payload header. The UPF assigns the PSI value for those PDUs using the MIHS layer value based on the above logic.

g. Marker Bit

As defined in the IETF draft “RTP Payload for Haptics,” the first non-silent packet after a period of haptic silence sets the Marker bit in the RTP header to one.

The first non-silence packet after a period of silence is important for the receiver to understand that non-silent MIHS packets are transmitted from this time onwards.

Thus, when the Marker bit field value in the RTP header of a haptics RTP packet is one, the corresponding PDU is set with higher importance or with a lower PSI value compared to the PDUs with Marker bit field values set to zero.

An RTP sender sets the PSI field value present in the PDU Set Marking RTP HE for silence MIHS units based on the above logic.

When the UPF receives the PDUs from the RTP sender and the PDU Set Marking RTP HE is not available in the PDUs it received, the UPF inspects the RTP packet and finds the Marker bit present in the RTP payload header. The UPF assigns the PSI value for those PDUs using the Marker bit value based on the above logic.

h. Identifying the PDU Set Marking RTP HE of Haptics Media

The 3GPP TS 29.314 specification defines various media types that can be carried by an application flow. The ApplicationFlowDescription data type lists the types of the media content present in a specific application flow.

For haptics media, the definition of MediaType present in Example 5.6.3.3 of TS 26.314 can be extended. FIG. 11 is a table 1100 illustrating a haptics extension of the definition of MediaType present in Example 5.6.3.3 of TS 26.314.

When haptics media content is transported using RTP packets, the media name in the “m=” line of the SDP message is set to haptics as defined in IETF draft “RTP Payload for Haptics.”

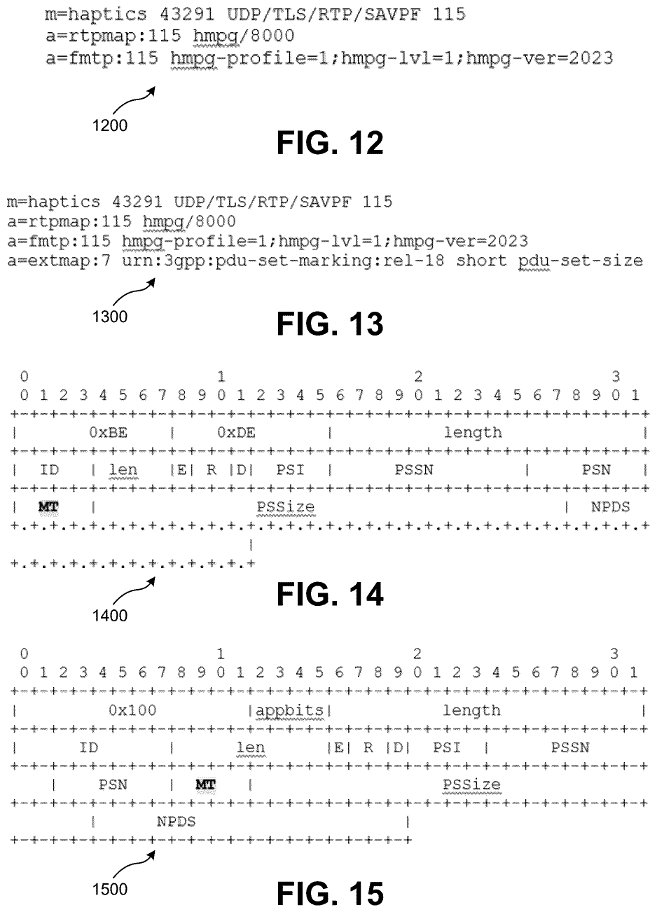

FIG. 12 is a diagram illustrating an example media representation 1200 corresponding to the hmpg RTP payload in SDP. The Payload Type of the haptics media is identified by parsing the m=haptics line in the SDP message. In the illustrated SDP example, the Payload Type value for haptics media is 115.

When an application data flow contains haptics media content, the mediaTransportParameters in the ApplicationFlowDescription type lists the haptics media type in the RtpPayloadInfo. rtpPayloadTypeList property. When a UPF receives PDUs of haptics media and other media content, it may parse the Payload Type (PT) values in the RTP header of RTP packets to detect the PDUs or PDU sets belonging to haptics media.

When haptics media content is transported using RTP, and the PDU Set Marking RTP HE is used for providing the PDU set information, then the media sender uses the SDP extmap attribute in the media description of the haptics RTP stream(s) as defined in Example 4.2.5 of TS 26.322.

FIG. 13 is a diagram illustrating an example media representation 1300 corresponding to the hmpg RTP payload with PDU Set Marking RTP HE in SDP. When an application data flow contains haptics media content, the RtpHeaderExtInfo. rtpHeaderExtID property in the ProtocolDescription lists the PDU Set Marking RTP HE identifier present in the a=extmap: line under the haptics media description in the SDP.

When the ProtocolDescription is available to the UPF, the UPF parses the RTP HE available in the received RTP packets and matches with the PDU Set Marking RTP HE identifier received from the ProtocolDescription. The UPF reads the PDU Set Marking RTP HE of those haptics RTP packets to identify the PDU set information of the haptics data. The UPF may use the PDU Set Importance field present in the PDU Set Marking RTP HE during the transport of haptics PDUs or PDU sets.

i. Pdu Set Multiplexing for Differentiated Handling

XR, multimodal, or interactive media services may send data traffic of different media components with different QoS requirements. Several media streams could be multiplexed over the same end-to-end transport layer connection. For example, in an XR service, several media streams or different layers of media streams could be multiplexed into a single transport layer connection with the same IP 5-tuple.

When haptics media data is part of XR, multimodal, or interactive services, the haptics media data may be multiplexed with other media streams and sent over a transport layer connection. UPF and RAN can identify the PDU set information of the haptics media PDUs and can support differentiated QoS for this multiplexed traffic flows. As the haptics media content is small, this traffic detection and differentiated handling of haptics media will add extra processing complexity on the UPF and the RAN nodes in the 5G System.

To avoid this processing complexity involved in the differentiated handling at UPF and RAN, haptics media data may be multiplexed with the other media data (e.g., video data) and can be transmitted from an RTP sender. This may be achieved by multiplexing haptics PDUs and other media PDUs into the same PDU set.

A PDU set may contain a set of PDUs from different media streams of different media types (e.g., haptics media PDUs and video PDUs). A PDU set, however, may not contain a set of PDUs from different media streams with the same media type.

To identify the type of the media content present in a PDU of a PDU set, the PDU Set Marking RTP HE can be extended to include the Media Type field as shown in FIGS. 14 and 15. FIG. 14 is a diagram illustrating a one-byte RTP HE 1400 for the marking of PDU sets. FIG. 15 is a diagram illustrating a two-byte RTP HE 1500 for the marking of PDU sets.

Media Type [MT] (4 bits): The media type of the current PDU within the PDU set. This field is equivalent to an enumeration MediaType specified in Example 5.6.3.3 of TS 29.314.

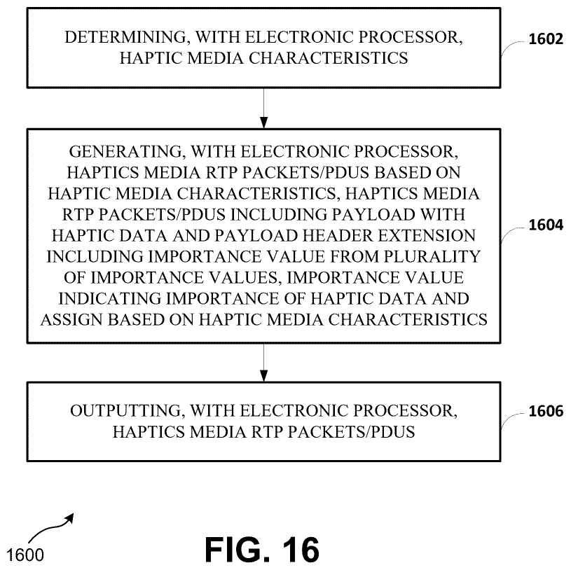

FIG. 16 is a flowchart illustrating an example method 1600 of encoding haptics media data. In some examples, the example method 1600 may be performed by an RTP sender (e.g., a UE or an application server as described above).

The method 1600 includes determining, with an electronic processor, haptic media characteristics (at block 1602). The method 1600 includes generating, with the electronic processor, a haptics media RTP packets/PDUs based on the haptic media characteristics, the haptics media RTP packets/PDUs including a payload with haptic data and a payload header extension including an importance value from a plurality of importance values, the importance value indicating an importance of the haptic data and assign based on the haptic media characteristics (at block 1604). The method 1600 also includes outputting, with the electronic processor, the haptics media RTP packets/PDUs (at block 1606).

In some examples, the haptic media characteristics include a MIHS unit type, a dependent MIHS unit, and MIHS unit layer information. In these examples, the plurality of importance values may include an independent importance value and a dependent importance value, and based on the dependent MIHS unit indicating that a MIHS unit is independently decodable by a haptics media decoder, the method 1600 may further include assigning, with the electronic processor, the importance value of the payload header extension to the independent importance value that is higher in importance than the dependent importance value. Additionally, in these examples, based on the dependent MIHS unit indicating that the MIHS unit is not independently decodable by the haptics media decoder, the method 1600 may further include assigning, with the electronic processor, the importance value of the payload header extension to the dependent importance value.

In some examples, the MIHS unit type indicates a MIHS unit is one of an initialization MIHS unit, a temporal MIHS unit, a spatial MIHS unit, a silent MIHS unit, a first aggregation packet (STAP), a second aggregation packet (MTAP), or a fragmentation unit.

In these examples, the plurality of importance values may include an initialization importance value and a non-initialization importance value, and based on the MIHS unit type indicating that the MIHS unit is the initialization MIHS unit, the method 1600 may further include assigning, with the electronic processor, the importance value of the payload header extension to the initialization importance value that is higher in importance than the non-initialization importance value.

In these examples, the plurality of importance values may include a spatial importance value, a dependent temporal importance value, and an initialization importance value, and based on the MIHS unit type indicating that the MIHS unit is the spatial MIHS unit, the method 1600 may further include assigning, with the electronic processor, the importance value of the payload header extension to the spatial importance value, the spatial importance value that is higher in importance than the dependent temporal importance value and lower in importance than the initialization importance value.

In these examples, the plurality of importance values may include an independent temporal importance value, a dependent temporal importance value, and a spatial importance value, and based on the MIHS unit type indicating that the MIHS unit is the temporal MIHS unit and the dependent MIHS unit indicating that the MIHS unit is independent, the method 1600 may further include assigning, with the electronic processor, the importance value of the payload header extension to the independent temporal importance value that is higher in importance than the dependent temporal importance value and the spatial importance value.

In these examples, the plurality of importance values may include a dependent temporal importance value, an initialization importance value, a spatial importance value, and an independent temporal importance value, and based on the MIHS unit type indicating that the MIHS unit is the temporal MIHS unit and the dependent MIHS unit indicating that the MIHS unit is dependent, the method 1600 may further include assigning, with the electronic processor, the importance value of the payload header extension to the dependent temporal importance value that is lower in importance than the initialization importance value, the spatial importance value, and the independent temporal importance value.

In these examples, the plurality of importance values may include a silent importance value and a non-silent importance value, and based on the MIHS unit type indicating that the MIHS unit is the silent MIHS unit, the method 1600 may further include assigning, with the electronic processor, the importance value of the payload header extension to the silent importance value that is lower in importance than the non-silent importance value.

In these examples, the plurality of importance values may include an initialization importance value, a spatial importance value, a dependent temporal importance value, and an independent temporal importance value, based on the MIHS unit type indicating that the MIHS unit is the fragmentation unit, the method 1600 may further include determining, with the electronic processor, whether a fragmentation unit header indicates the MIHS unit type is one of the initialization MIHS unit, the spatial MIHS unit, or the temporal MIHS unit.

Responsive to determining that the fragmentation unit header indicates the MIHS unit type is the initialization MIHS unit, the method 1600 may further include assigning, with the electronic processor, the importance value of the payload header extension to the initialization importance value that is equal to or higher in importance than the spatial importance value.

Responsive to determining that the fragmentation unit indicates the MIHS unit type is the spatial MIHS unit, the method 1600 may further include assigning, with the electronic processor, the importance value of the payload header extension to the spatial importance value that is equal to or slightly lower in importance than the initialization importance value.

Responsive to determining that the fragmentation unit indicates the MIHS unit type is the temporal MIHS unit, the method 1600 may further include determining whether the MIHS unit is a dependent temporal MIHS unit or an independent temporal MIHS unit.

Responsive to determining that the MIHS unit is the dependent temporal MIHS unit, the method 1600 may further include assigning, with the electronic processor, the importance value of the payload header extension to the dependent temporal importance value that is lower in importance than the initialization importance value, the spatial importance value, and the independent temporal importance value.

Responsive to determining that the MIHS unit is the independent temporal MIHS unit, the method 1600 may also further include assigning, with the electronic processor, the importance value of the payload header extension to the independent temporal importance value that is equal to in importance as the spatial importance value.

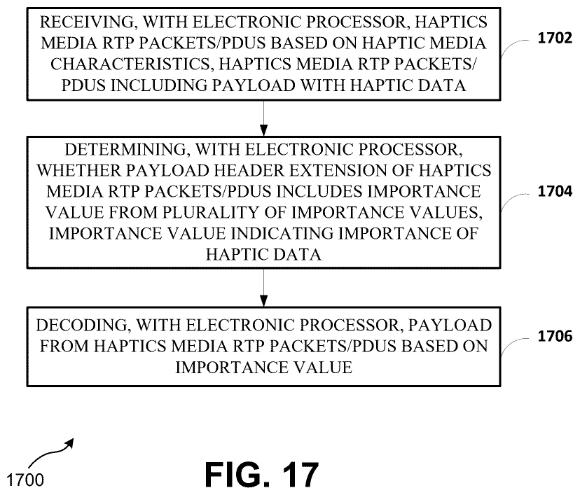

FIG. 17 is a flowchart illustrating an example method 1700 of decoding a haptics media data. In some examples, the example method 1700 may be performed by an RTP receiver (e.g., a UE or an application server as described above). The method 1700 includes receiving, with a electronic processor, a haptics media RTP packets/PDUs based on haptic media characteristics, the haptics media RTP packets/PDUs including a payload with haptic data (at block 1702). The method 1700 includes determining, with the electronic processor, whether a payload header extension of the haptics media RTP packets/PDUs includes an importance value from a plurality of importance values, the importance value indicating an importance of the haptic data (at block 1704). The method 1700 also includes decoding, with the electronic processor, the payload from the haptics media RTP packets/PDUs based on the importance value (at block 1706).

In some examples, the haptic media characteristics include a MIHS unit type, a dependent MIHS unit, and MIHS unit layer information.

In some examples, responsive to determining that the payload header extension of the haptics media RTP packets/PDUs includes the importance value from the plurality of importance values, the method 1700 may further include determining, with the electronic processor, whether the importance value is one of an initialization importance value, a spatial importance value, a dependent temporal importance value, an independent temporal importance value, or a silent importance value, and decoding, with the electronic processor, the payload from the haptics media RTP packets/PDUs based on the importance value includes decoding the payload from the haptics media RTP packets/PDUs based on the one of the initialization importance value, the spatial importance value, the dependent temporal importance value, the independent temporal importance value, or the silent importance value that is determined.

In some examples, responsive to determining that the payload header extension of the haptics media RTP packets/PDUs does not include the importance value from the plurality of importance values, the method 1700 may further include determining, with the electronic processor, whether a MIHS unit is independently decodable by a haptics media decoder.

Responsive to determining that the MIHS unit is not independently decodable by the haptics media decoder, the method 1700 may further include assigning, with the electronic processor, the importance value to a dependent importance value that is lower in importance than an independent importance value.

Responsive to determining that the MIHS unit is independently decodable by the haptics media decoder, the method 1700 may also further include assigning, with the electronic processor, the importance value to the independent importance value.

In some examples, responsive to determining that the payload header extension of the haptics media RTP packets/PDUs does not include the importance value from the plurality of importance values, the method 1700 may further include determining, with the electronic processor, whether a MIHS unit type of the payload header extension indicates that a MIHS unit is a spatial MIHS unit.

Responsive to determining that the MIHS unit type indicates that the MIHS unit is the spatial MIHS unit, the method 1700 may also further include assigning, with the electronic processor, the importance value of the payload header extension to a spatial importance value, the spatial importance value that is higher in importance than a dependent temporal importance value and lower in importance than a initialization importance value.

In some examples, responsive to determining that the payload header extension of the haptics media RTP packets/PDUs does not include the importance value from the plurality of importance values, the method 1700 may further include determining, with the electronic processor, whether a MIHS unit type of the payload header extension indicates that a MIHS unit is a temporal MIHS unit and a dependent MIHS unit indicates that the MIHS unit is independent.

Responsive to determining that the MIHS unit type indicates that the MIHS unit is the temporal MIHS unit and the dependent MIHS unit indicates that the MIHS unit is independent, the method 1700 may also further include assigning, with the electronic processor, the importance value of the payload header extension to an independent temporal importance value that is higher in importance than a dependent temporal importance value and equal in importance with a spatial importance value.

In some examples, responsive to determining that the payload header extension of the haptics media RTP packets/PDUs does not include the importance value from the plurality of importance values, the method 1700 may further include determining, with the electronic processor, whether a MIHS unit type of the payload header extension indicates that a MIHS unit is a temporal MIHS unit and a dependent MIHS unit indicates that the MIHS unit is dependent.

Responsive to determining that the MIHS unit type indicates that the MIHS unit is the temporal MIHS unit and the dependent MIHS unit indicating that the MIHS unit is dependent, the method 1700 may also further include assigning, with the electronic processor, the importance value of the payload header extension to a dependent temporal importance value that is lower in importance than an initialization importance value, a spatial importance value, and an independent temporal importance value.

In some examples, responsive to determining that the payload header extension of the haptics media RTP packets/PDUs does not include the importance value from the plurality of importance values, the method 1700 may further include determining, with the electronic processor, whether a MIHS unit type of the payload header extension indicates that that a MIHS unit is a silent MIHS unit.

Responsive to determining that the MIHS unit type indicates that that the MIHS unit is the silent MIHS unit, the method 1700 may also further include assigning, with the electronic processor, the importance value of the payload header extension to a silent importance value that is lower in importance than a non-silent importance value.

In some examples, responsive to determining that the payload header extension of the haptics media RTP packets/PDUs does not include the importance value from the plurality of importance values, the method 1700 may further include determining, with the electronic processor, whether a MIHS unit type of the payload header extension indicates that a MIHS unit is a fragmentation unit.

Responsive to determining that the MIHS unit type indicates that the MIHS unit is the fragmentation unit, the method 1700 may further include determining, with the electronic processor, whether a fragmentation unit header indicates the MIHS unit type is one of an initialization MIHS unit, a spatial MIHS unit, or a temporal MIHS unit.

Responsive to determining that the fragmentation unit header indicates the MIHS unit type is the initialization MIHS unit, the method 1700 may further include assigning, with the electronic processor, the importance value of the payload header extension to an initialization importance value that is equal to or higher in importance than a spatial importance value.

Responsive to determining that the fragmentation unit indicates the MIHS unit type is the spatial MIHS unit, the method 1700 may further include assigning, with the electronic processor, the importance value of the payload header extension to the spatial importance value that is equal to or lower in importance than the initialization importance value.

Responsive to determining that the fragmentation unit indicates the MIHS unit type is the temporal MIHS unit, the method 1700 may further include determining whether the MIHS unit is a dependent temporal MIHS unit or an independent temporal MIHS unit.

Responsive to determining that the MIHS unit is the dependent temporal MIHS unit, the method 1700 may further include assigning, with the electronic processor, the importance value of the payload header extension to a dependent temporal importance value that is lower in importance than the initialization importance value, the spatial importance value, and an independent temporal importance value.

Responsive to determining that the MIHS unit is the independent temporal MIHS unit, the method 1700 may also further include assigning, with the electronic processor, the importance value of the payload header extension to the independent temporal importance value that is equal to in importance as the spatial importance value.

One or more embodiments provide a computer program comprising instructions which when executed by one or more processors cause such processors to perform the encoding and/or decoding methods according to any of the embodiments described above. One or more embodiments also provide a computer readable storage medium having stored thereon instructions for encoding or decoding video data according to the methods described above.

One or more embodiments provide a computer readable storage medium having stored thereon video data generated according to the methods described above. One or more embodiments also provide a method and apparatus for transmitting or receiving video data generated according to the methods described above.

The following are enumerated examples of the methods, devices, and computer-readable media of the disclosure.

Example 1: a method comprising: determining, with an electronic processor, haptic media characteristics; generating, with the electronic processor, a haptics media RTP packets/PDUs based on the haptic media characteristics, the haptics media RTP packets/PDUs including a payload with haptic data and a payload header extension including an importance value from a plurality of importance values, the importance value indicating an importance of the haptic data and assign based on the haptic media characteristics; and outputting, with the electronic processor, the haptics media RTP packets/PDUs.

Example 2: the method of Example 1, wherein the haptic media characteristics include a MIHS unit type, a dependent MIHS unit, and MIHS unit layer information.

Example 3: the method of Example 2, wherein the plurality of importance values includes an independent importance value and a dependent importance value, and wherein, based on the dependent MIHS unit indicating that a MIHS unit is independently decodable by a haptics media decoder, assigning, with the electronic processor, the importance value of the payload header extension to the independent importance value that is higher in importance than the dependent importance value.

Example 4: the method of Example 3, wherein, based on the dependent MIHS unit indicating that the MIHS unit is not independently decodable by the haptics media decoder, assigning, with the electronic processor, the importance value of the payload header extension to the dependent importance value.

Example 5: the method of any of Examples 2-4, wherein the MIHS unit type indicates a MIHS unit is one of an initialization MIHS unit, a temporal MIHS unit, a spatial MIHS unit, a silent MIHS unit, a first aggregation packet (STAP), a second aggregation packet (MTAP), or a fragmentation unit.

Example 6: the method of Example 5, wherein the plurality of importance values includes an initialization importance value and a non-initialization importance value, and wherein, based on the MIHS unit type indicating that the MIHS unit is the initialization MIHS unit, assigning, with the electronic processor, the importance value of the payload header extension to the initialization importance value that is higher in importance than the non-initialization importance value.

Example 7: the method of any of Examples 5 or 6, wherein the plurality of importance values includes a spatial importance value, a dependent temporal importance value, and an initialization importance value, and wherein, based on the MIHS unit type indicating that the MIHS unit is the spatial MIHS unit, assigning, with the electronic processor, the importance value of the payload header extension to the spatial importance value, the spatial importance value that is higher in importance than the dependent temporal importance value and lower in importance than the initialization importance value.

Example 8: the method of any of Examples 5-7, wherein the plurality of importance values includes an independent temporal importance value, a dependent temporal importance value, and a spatial importance value, and wherein, based on the MIHS unit type indicating that the MIHS unit is the temporal MIHS unit and the dependent MIHS unit indicating that the MIHS unit is independent, assigning, with the electronic processor, the importance value of the payload header extension to the independent temporal importance value that is higher in importance than the dependent temporal importance value and the spatial importance value.

Example 9: the method of any of Examples 5-8, wherein the plurality of importance values includes a dependent temporal importance value, an initialization importance value, a spatial importance value, and an independent temporal importance value, and wherein, based on the MIHS unit type indicating that the MIHS unit is the temporal MIHS unit and the dependent MIHS unit indicating that the MIHS unit is dependent, assigning, with the electronic processor, the importance value of the payload header extension to the dependent temporal importance value that is lower in importance than the initialization importance value, the spatial importance value, and the independent temporal importance value.

Example 10: the method of any of Examples 5-9, wherein the plurality of importance values includes a silent importance value and a non-silent importance value, and wherein, based on the MIHS unit type indicating that the MIHS unit is the silent MIHS unit, assigning, with the electronic processor, the importance value of the payload header extension to the silent importance value that is lower in importance than the non-silent importance value.

Example 11: the method of any of Examples 5-10, wherein the plurality of importance values includes an initialization importance value, a spatial importance value, a dependent temporal importance value, and an independent temporal importance value wherein, based on the MIHS unit type indicating that the MIHS unit is the fragmentation unit, determining, with the electronic processor, whether a fragmentation unit header indicates the MIHS unit type is one of the initialization MIHS unit, the spatial MIHS unit, or the temporal MIHS unit, wherein, responsive to determining that the fragmentation unit header indicates the MIHS unit type is the initialization MIHS unit, assigning, with the electronic processor, the importance value of the payload header extension to the initialization importance value that is equal to or higher in importance than the spatial importance value, wherein, responsive to determining that the fragmentation unit indicates the MIHS unit type is the spatial MIHS unit, assigning, with the electronic processor, the importance value of the payload header extension to the spatial importance value that is equal to or slightly lower in importance than the initialization importance value, wherein, responsive to determining that the fragmentation unit indicates the MIHS unit type is the temporal MIHS unit, determining whether the MIHS unit is a dependent temporal MIHS unit or an independent temporal MIHS unit, wherein, responsive to determining that the MIHS unit is the dependent temporal MIHS unit, assigning, with the electronic processor, the importance value of the payload header extension to the dependent temporal importance value that is lower in importance than the initialization importance value, the spatial importance value, and the independent temporal importance value, and wherein, responsive to determining that the MIHS unit is the independent temporal MIHS unit, assigning, with the electronic processor, the importance value of the payload header extension to the independent temporal importance value that is equal to in importance as the spatial importance value.

Example 12: a non-transitory computer-readable medium comprising instructions that, when executed by an electronic processor, cause an electronic processor to perform a set of operations comprising: determining haptic media characteristics; generating a haptics media RTP packets/PDUs based on the haptic media characteristics, the haptics media RTP packets/PDUs including a payload with haptic data and a payload header extension including an importance value from a plurality of importance values, the importance value indicating an importance of the haptic data and assign based on the haptic media characteristics; and outputting the haptics media RTP packets/PDUs.

Example 13: the non-transitory computer-readable medium of Example 12, wherein the haptic media characteristics include a MIHS unit type, a dependent MIHS unit, and MIHS unit layer information.

Example 14: the non-transitory computer-readable medium of Example 13, wherein the plurality of importance values includes an independent importance value and a dependent importance value, and wherein, based on the dependent MIHS unit indicating that a MIHS unit is independently decodable by a haptics media decoder, assigning the importance value of the payload header extension to the independent importance value that is higher in importance than the dependent importance value.

Example 15: the non-transitory computer-readable medium of Example 14, wherein, based on the dependent MIHS unit indicating that the MIHS unit is not independently decodable by the haptics media decoder, assigning the importance value of the payload header extension to the dependent importance value.

Example 16: the non-transitory computer-readable medium of any of Examples 13-15, wherein the MIHS unit type indicates a MIHS unit is one of an initialization MIHS unit, a temporal MIHS unit, a spatial MIHS unit, a silent MIHS unit, a first aggregation packet (STAP), a second aggregation packet (MTAP), or a fragmentation unit.

Example 17: the non-transitory computer-readable medium of Example 16, wherein the plurality of importance values includes an initialization importance value and a non-initialization importance value, and wherein, based on the MIHS unit type indicating that the MIHS unit is the initialization MIHS unit, assigning the importance value of the payload header extension to the initialization importance value that is higher in importance than the non-initialization importance value.

Example 18: the non-transitory computer-readable medium of any of Examples 16 or 17, wherein the plurality of importance values includes a spatial importance value, a dependent temporal importance value, and an initialization importance value, and wherein, based on the MIHS unit type indicating that the MIHS unit is the spatial MIHS unit, assigning the importance value of the payload header extension to the spatial importance value, the spatial importance value that is higher in importance than the dependent temporal importance value and lower in importance than the initialization importance value.

Example 19: the non-transitory computer-readable medium of any of Examples 16-18, wherein the plurality of importance values includes an independent temporal importance value, a dependent temporal importance value, and a spatial importance value, and wherein, based on the MIHS unit type indicating that the MIHS unit is the temporal MIHS unit and the dependent MIHS unit indicating that the MIHS unit is independent, assigning the importance value of the payload header extension to the independent temporal importance value that is higher in importance than the dependent temporal importance value and the spatial importance value.

Example 20: the non-transitory computer-readable medium of any of Examples 16-19, wherein the plurality of importance values includes a dependent temporal importance value, an initialization importance value, a spatial importance value, and an independent temporal importance value, and wherein, based on the MIHS unit type indicating that the MIHS unit is the temporal MIHS unit and the dependent MIHS unit indicating that the MIHS unit is dependent, assigning the importance value of the payload header extension to the dependent temporal importance value that is lower in importance than the initialization importance value, the spatial importance value, and the independent temporal importance value.

Example 21: the non-transitory computer-readable medium of any of Examples 16-20, wherein the plurality of importance values includes a silent importance value and a non-silent importance value, and wherein, based on the MIHS unit type indicating that the MIHS unit is the silent MIHS unit, assigning the importance value of the payload header extension to the silent importance value that is lower in importance than the non-silent importance value.

Example 22: the non-transitory computer-readable medium of any of Examples 16-21, wherein the plurality of importance values includes an initialization importance value, a spatial importance value, a dependent temporal importance value, and an independent temporal importance value wherein, based on the MIHS unit type indicating that the MIHS unit is the fragmentation unit, determining whether a fragmentation unit header indicates the MIHS unit type is one of the initialization MIHS unit, the spatial MIHS unit, or the temporal MIHS unit, wherein, responsive to determining that the fragmentation unit header indicates the MIHS unit type is the initialization MIHS unit, assigning the importance value of the payload header extension to the initialization importance value that is equal to or higher in importance than the spatial importance value, wherein, responsive to determining that the fragmentation unit indicates the MIHS unit type is the spatial MIHS unit, assigning the importance value of the payload header extension to the spatial importance value that is equal to or slightly lower in importance than the initialization importance value, wherein, responsive to determining that the fragmentation unit indicates the MIHS unit type is the temporal MIHS unit, determining whether the MIHS unit is a dependent temporal MIHS unit or an independent temporal MIHS unit, wherein, responsive to determining that the MIHS unit is the dependent temporal MIHS unit, assigning the importance value of the payload header extension to the dependent temporal importance value that is lower in importance than the initialization importance value, the spatial importance value, and the independent temporal importance value, and wherein, responsive to determining that the MIHS unit is the independent temporal MIHS unit, assigning the importance value of the payload header extension to the independent temporal importance value that is equal to in importance as the spatial importance value.

Example 23: a device comprising: an electronic processor configured to: determine haptic media characteristics; generate a haptics media RTP packets/PDUs based on the haptic media characteristics, the haptics media RTP packets/PDUs including a payload with haptic data and a payload header extension including an importance value from a plurality of importance values, the importance value indicating an importance of the haptic data and assign based on the haptic media characteristics; and output the haptics media RTP packets/PDUs.

Example 24: the device of Example 23, wherein the haptic media characteristics include a MIHS unit type, a dependent MIHS unit, and MIHS unit layer information.

Example 25: the device of Example 24, wherein the plurality of importance values includes an independent importance value and a dependent importance value, and wherein, based on the dependent MIHS unit indicating that a MIHS unit is independently decodable by a haptics media decoder, the electronic processor is further configured to assign the importance value of the payload header extension to the independent importance value that is higher in importance than the dependent importance value.

Example 26: the device of Example 25, wherein, based on the dependent MIHS unit indicating that the MIHS unit is not independently decodable by the haptics media decoder, the electronic processor is further configured to assign the importance value of the payload header extension to the dependent importance value.

Example 27: the device of any of Examples 24-26, wherein the MIHS unit type indicates a MIHS unit is one of an initialization MIHS unit, a temporal MIHS unit, a spatial MIHS unit, a silent MIHS unit, a first aggregation packet (STAP), a second aggregation packet (MTAP), or a fragmentation unit.

Example 28: the device of Example 27, wherein the plurality of importance values includes an initialization importance value and a non-initialization importance value, and wherein, based on the MIHS unit type indicating that the MIHS unit is the initialization MIHS unit, the electronic processor is further configured to assign the importance value of the payload header extension to the initialization importance value that is higher in importance than the non-initialization importance value.

Example 29: the device of any of Examples 27 or 28, wherein the plurality of importance values includes a spatial importance value, a dependent temporal importance value, and an initialization importance value, and wherein, based on the MIHS unit type indicating that the MIHS unit is the spatial MIHS unit, the electronic processor is further configured to assign the importance value of the payload header extension to the spatial importance value, the spatial importance value that is higher in importance than the dependent temporal importance value and lower in importance than the initialization importance value.

Example 30: the device of any of Examples 27-29, wherein the plurality of importance values includes an independent temporal importance value, a dependent temporal importance value, and a spatial importance value, and wherein, based on the MIHS unit type indicating that the MIHS unit is the temporal MIHS unit and the dependent MIHS unit indicating that the MIHS unit is independent, the electronic processor is further configured to assign the importance value of the payload header extension to the independent temporal importance value that is higher in importance than the dependent temporal importance value and the spatial importance value.

Example 31: the device of any of Examples 27-30, wherein the plurality of importance values includes a dependent temporal importance value, an initialization importance value, a spatial importance value, and an independent temporal importance value, and wherein, based on the MIHS unit type indicating that the MIHS unit is the temporal MIHS unit and the dependent MIHS unit indicating that the MIHS unit is dependent, the electronic processor is further configured to assign the importance value of the payload header extension to the dependent temporal importance value that is lower in importance than the initialization importance value, the spatial importance value, and the independent temporal importance value.

Example 32: the device of any of Examples 27-31, wherein the plurality of importance values includes a silent importance value and a non-silent importance value, and wherein, based on the MIHS unit type indicating that the MIHS unit is the silent MIHS unit, the electronic processor is further configured to assign the importance value of the payload header extension to the silent importance value that is lower in importance than the non-silent importance value.

Example 33: the device of any of Examples 27-32, wherein the plurality of importance values includes an initialization importance value, a spatial importance value, a dependent temporal importance value, and an independent temporal importance value wherein, based on the MIHS unit type indicating that the MIHS unit is the fragmentation unit, determining whether a fragmentation unit header indicates the MIHS unit type is one of the initialization MIHS unit, the spatial MIHS unit, or the temporal MIHS unit, wherein, responsive to determining that the fragmentation unit header indicates the MIHS unit type is the initialization MIHS unit, the electronic processor is further configured to assign the importance value of the payload header extension to the initialization importance value that is equal to or higher in importance than the spatial importance value, wherein, responsive to determining that the fragmentation unit indicates the MIHS unit type is the spatial MIHS unit, the electronic processor is further configured to assign the importance value of the payload header extension to the spatial importance value that is equal to or slightly lower in importance than the initialization importance value, wherein, responsive to determining that the fragmentation unit indicates the MIHS unit type is the temporal MIHS unit, the electronic processor is further configured to determine whether the MIHS unit is a dependent temporal MIHS unit or an independent temporal MIHS unit, wherein, responsive to determining that the MIHS unit is the dependent temporal MIHS unit, the electronic processor is further configured to assign the importance value of the payload header extension to the dependent temporal importance value that is lower in importance than the initialization importance value, the spatial importance value, and the independent temporal importance value, and wherein, responsive to determining that the MIHS unit is the independent temporal MIHS unit, the electronic processor is further configured to assign the importance value of the payload header extension to the independent temporal importance value that is equal to in importance as the spatial importance value.

Example 34: a non-transitory computer-readable medium comprising instructions that, when executed by an electronic processor, cause an electronic processor to perform a set of operations comprising: receiving a haptics media RTP packets/PDUs based on haptic media characteristics, the haptics media RTP packets/PDUs including a payload with haptic data; determining whether a payload header extension of the haptics media RTP packets/PDUs includes an importance value from a plurality of importance values, the importance value indicating an importance of the haptic data; and decoding the payload from the haptics media RTP packets/PDUs based on the importance value.

Example 35: the non-transitory computer-readable medium of Example 34, wherein the haptic media characteristics include a MIHS unit type, a dependent MIHS unit, and MIHS unit layer information.

Example 36: the non-transitory computer-readable medium of any of Examples 34 or 35, wherein, responsive to determining that the payload header extension of the haptics media RTP packets/PDUs includes the importance value from the plurality of importance values, determining whether the importance value is one of an initialization importance value, a spatial importance value, a dependent temporal importance value, an independent temporal importance value, or a silent importance value, and wherein decoding the payload from the haptics media RTP packets/PDUs based on the importance value includes decoding the payload from the haptics media RTP packets/PDUs based on the one of the initialization importance value, the spatial importance value, the dependent temporal importance value, the independent temporal importance value, or the silent importance value that is determined.

Example 37: the non-transitory computer-readable medium of any of Examples 34-36, wherein, responsive to determining that the payload header extension of the haptics media RTP packets/PDUs does not include the importance value from the plurality of importance values, determining whether a MIHS unit is independently decodable by a haptics media decoder, wherein, responsive to determining that the MIHS unit is not independently decodable by the haptics media decoder, assigning the importance value to a dependent importance value that is lower in importance than an independent importance value, and wherein, responsive to determining that the MIHS unit is independently decodable by the haptics media decoder, assigning the importance value to the independent importance value.

Example 38: the non-transitory computer-readable medium of any of Examples 34-37, wherein, responsive to determining that the payload header extension of the haptics media RTP packets/PDUs does not include the importance value from the plurality of importance values, determining whether a MIHS unit type of the payload header extension indicates that a MIHS unit is a spatial MIHS unit, and wherein, responsive to determining that the MIHS unit type indicates that the MIHS unit is the spatial MIHS unit, assigning the importance value of the payload header extension to a spatial importance value, the spatial importance value that is higher in importance than a dependent temporal importance value and lower in importance than a initialization importance value.

Example 39: the non-transitory computer-readable medium of any of Examples 34-38, wherein, responsive to determining that the payload header extension of the haptics media RTP packets/PDUs does not include the importance value from the plurality of importance values, determining whether a MIHS unit type of the payload header extension indicates that a MIHS unit is a temporal MIHS unit and a dependent MIHS unit indicates that the MIHS unit is independent, and wherein, responsive to determining that the MIHS unit type indicates that the MIHS unit is the temporal MIHS unit and the dependent MIHS unit indicates that the MIHS unit is independent, assigning the importance value of the payload header extension to an independent temporal importance value that is higher in importance than a dependent temporal importance value and equal in importance with a spatial importance value.

Example 40: the non-transitory computer-readable medium of any of Examples 34-39, wherein, responsive to determining that the payload header extension of the haptics media RTP packets/PDUs does not include the importance value from the plurality of importance values, determining whether a MIHS unit type of the payload header extension indicates that a MIHS unit is a temporal MIHS unit and a dependent MIHS unit indicates that the MIHS unit is dependent, and wherein, responsive to determining that the MIHS unit type indicates that the MIHS unit is the temporal MIHS unit and the dependent MIHS unit indicating that the MIHS unit is dependent, assigning the importance value of the payload header extension to a dependent temporal importance value that is lower in importance than an initialization importance value, a spatial importance value, and an independent temporal importance value.

Example 41: the non-transitory computer-readable medium of any of Examples 34-40, wherein, responsive to determining that the payload header extension of the haptics media RTP packets/PDUs does not include the importance value from the plurality of importance values, determining, with the electronic processor, whether a MIHS unit type of the payload header extension indicates that that a MIHS unit is a silent MIHS unit, and wherein, responsive to determining that the MIHS unit type indicates that that the MIHS unit is the silent MIHS unit, assigning, with the electronic processor, the importance value of the payload header extension to a silent importance value that is lower in importance than a non-silent importance value.

Example 42: the non-transitory computer-readable medium of any of Examples 34-41, wherein, responsive to determining that the payload header extension of the haptics media RTP packets/PDUs does not include the importance value from the plurality of importance values, determining whether a MIHS unit type of the payload header extension indicates that a MIHS unit is a fragmentation unit, and wherein, responsive to determining that the MIHS unit type indicates that the MIHS unit is the fragmentation unit, determining whether a fragmentation unit header indicates the MIHS unit type is one of an initialization MIHS unit, a spatial MIHS unit, or a temporal MIHS unit, wherein, responsive to determining that the fragmentation unit header indicates the MIHS unit type is the initialization MIHS unit, assigning the importance value of the payload header extension to an initialization importance value that is equal to or higher in importance than a spatial importance value, wherein, responsive to determining that the fragmentation unit indicates the MIHS unit type is the spatial MIHS unit, assigning the importance value of the payload header extension to the spatial importance value that is equal to or lower in importance than the initialization importance value, wherein, responsive to determining that the fragmentation unit indicates the MIHS unit type is the temporal MIHS unit, determining whether the MIHS unit is a dependent temporal MIHS unit or an independent temporal MIHS unit, wherein, responsive to determining that the MIHS unit is the dependent temporal MIHS unit, assigning the importance value of the payload header extension to a dependent temporal importance value that is lower in importance than the initialization importance value, the spatial importance value, and an independent temporal importance value, and wherein, responsive to determining that the MIHS unit is the independent temporal MIHS unit, assigning the importance value of the payload header extension to the independent temporal importance value that is equal to in importance as the spatial importance value.

Example 43: a device comprising: an electronic processor configured to: receive a haptics media RTP packets/PDUs based on haptic media characteristics, the haptics media RTP packets/PDUs including a payload with haptic data, determine whether a payload header extension of the haptics media RTP packets/PDUs includes an importance value from a plurality of importance values, the importance value indicating an importance of the haptic data, and decode the payload from the haptics media RTP packets/PDUs based on the importance value.

Example 44: the device of Example 43, wherein the haptic media characteristics include a MIHS unit type, a dependent MIHS unit, and MIHS unit layer information.

Example 45: the device of any of Examples 43 or 44, wherein, responsive to determining that the payload header extension of the haptics media RTP packets/PDUs includes the importance value from the plurality of importance values, determining whether the importance value is one of an initialization importance value, a spatial importance value, a dependent temporal importance value, an independent temporal importance value, or a silent importance value, and wherein decoding the payload from the haptics media RTP packets/PDUs based on the importance value includes decoding the payload from the haptics media RTP packets/PDUs based on the one of the initialization importance value, the spatial importance value, the dependent temporal importance value, the independent temporal importance value, or the silent importance value that is determined.

Example 46: the device of any of Examples 43-45, wherein, responsive to determining that the payload header extension of the haptics media RTP packets/PDUs does not include the importance value from the plurality of importance values, determining whether a MIHS unit is independently decodable by a haptics media decoder, wherein, responsive to determining that the MIHS unit is not independently decodable by the haptics media decoder, assigning the importance value to a dependent importance value that is lower in importance than an independent importance value, and wherein, responsive to determining that the MIHS unit is independently decodable by the haptics media decoder, assigning the importance value to the independent importance value.

Example 47: the device of any of Examples 43-46, wherein, responsive to determining that the payload header extension of the haptics media RTP packets/PDUs does not include the importance value from the plurality of importance values, determining whether a MIHS unit type of the payload header extension indicates that a MIHS unit is a spatial MIHS unit, and wherein, responsive to determining that the MIHS unit type indicates that the MIHS unit is the spatial MIHS unit, assigning the importance value of the payload header extension to a spatial importance value, the spatial importance value that is higher in importance than a dependent temporal importance value and lower in importance than a initialization importance value.

Example 48: the device of any of Examples 43-47, wherein, responsive to determining that the payload header extension of the haptics media RTP packets/PDUs does not include the importance value from the plurality of importance values, determining whether a MIHS unit type of the payload header extension indicates that a MIHS unit is a temporal MIHS unit and a dependent MIHS unit indicates that the MIHS unit is independent, and wherein, responsive to determining that the MIHS unit type indicates that the MIHS unit is the temporal MIHS unit and the dependent MIHS unit indicates that the MIHS unit is independent, assigning the importance value of the payload header extension to an independent temporal importance value that is higher in importance than a dependent temporal importance value and equal in importance with a spatial importance value.

Example 49: the device of any of Examples 43-48, wherein, responsive to determining that the payload header extension of the haptics media RTP packets/PDUs does not include the importance value from the plurality of importance values, determining whether a MIHS unit type of the payload header extension indicates that a MIHS unit is a temporal MIHS unit and a dependent MIHS unit indicates that the MIHS unit is dependent, and wherein, responsive to determining that the MIHS unit type indicates that the MIHS unit is the temporal MIHS unit and the dependent MIHS unit indicating that the MIHS unit is dependent, assigning the importance value of the payload header extension to a dependent temporal importance value that is lower in importance than an initialization importance value, a spatial importance value, and an independent temporal importance value.

Example 50: the device of any of Examples 43-49, wherein, responsive to determining that the payload header extension of the haptics media RTP packets/PDUs does not include the importance value from the plurality of importance values, determining, with the electronic processor, whether a MIHS unit type of the payload header extension indicates that that a MIHS unit is a silent MIHS unit, and wherein, responsive to determining that the MIHS unit type indicates that that the MIHS unit is the silent MIHS unit, assigning, with the electronic processor, the importance value of the payload header extension to a silent importance value that is lower in importance than a non-silent importance value.

Example 51: the device of any of Examples 43-50, wherein, responsive to determining that the payload header extension of the haptics media RTP packets/PDUs does not include the importance value from the plurality of importance values, determining whether a MIHS unit type of the payload header extension indicates that a MIHS unit is a fragmentation unit, and wherein, responsive to determining that the MIHS unit type indicates that the MIHS unit is the fragmentation unit, determining whether a fragmentation unit header indicates the MIHS unit type is one of an initialization MIHS unit, a spatial MIHS unit, or a temporal MIHS unit, wherein, responsive to determining that the fragmentation unit header indicates the MIHS unit type is the initialization MIHS unit, assigning the importance value of the payload header extension to an initialization importance value that is equal to or higher in importance than a spatial importance value, wherein, responsive to determining that the fragmentation unit indicates the MIHS unit type is the spatial MIHS unit, assigning the importance value of the payload header extension to the spatial importance value that is equal to or lower in importance than the initialization importance value, wherein, responsive to determining that the fragmentation unit indicates the MIHS unit type is the temporal MIHS unit, determining whether the MIHS unit is a dependent temporal MIHS unit or an independent temporal MIHS unit, wherein, responsive to determining that the MIHS unit is the dependent temporal MIHS unit, assigning the importance value of the payload header extension to a dependent temporal importance value that is lower in importance than the initialization importance value, the spatial importance value, and an independent temporal importance value, and wherein, responsive to determining that the MIHS unit is the independent temporal MIHS unit, assigning the importance value of the payload header extension to the independent temporal importance value that is equal to in importance as the spatial importance value.

Example 52: a method comprising: receiving, with a electronic processor, a haptics media RTP packets/PDUs based on haptic media characteristics, the haptics media RTP packets/PDUs including a payload with haptic data; determining, with the electronic processor, whether a payload header extension of the haptics media RTP packets/PDUs includes an importance value from a plurality of importance values, the importance value indicating an importance of the haptic data; and decoding, with the electronic processor, the payload from the haptics media RTP packets/PDUs based on the importance value.

Example 53: the method of Example 52, wherein the haptic media characteristics include a MIHS unit type, a dependent MIHS unit, and MIHS unit layer information.

Example 54: the method of any of Examples 52 or 53, wherein, responsive to determining that the payload header extension of the haptics media RTP packets/PDUs includes the importance value from the plurality of importance values, determining, with the electronic processor, whether the importance value is one of an initialization importance value, a spatial importance value, a dependent temporal importance value, an independent temporal importance value, or a silent importance value, and wherein decoding, with the electronic processor, the payload from the haptics media RTP packets/PDUs based on the importance value includes decoding the payload from the haptics media RTP packets/PDUs based on the one of the initialization importance value, the spatial importance value, the dependent temporal importance value, the independent temporal importance value, or the silent importance value that is determined.

Example 55: the method of any of Examples 52-54, wherein, responsive to determining that the payload header extension of the haptics media RTP packets/PDUs does not include the importance value from the plurality of importance values, determining, with the electronic processor, whether a MIHS unit is independently decodable by a haptics media decoder, wherein, responsive to determining that the MIHS unit is not independently decodable by the haptics media decoder, assigning, with the electronic processor, the importance value to a dependent importance value that is lower in importance than an independent importance value, and wherein, responsive to determining that the MIHS unit is independently decodable by the haptics media decoder, assigning, with the electronic processor, the importance value to the independent importance value.

Example 56: the method of any of Examples 52-55, wherein, responsive to determining that the payload header extension of the haptics media RTP packets/PDUs does not include the importance value from the plurality of importance values, determining, with the electronic processor, whether a MIHS unit type of the payload header extension indicates that a MIHS unit is a spatial MIHS unit, and wherein, responsive to determining that the MIHS unit type indicates that the MIHS unit is the spatial MIHS unit, assigning, with the electronic processor, the importance value of the payload header extension to a spatial importance value, the spatial importance value that is higher in importance than a dependent temporal importance value and lower in importance than a initialization importance value.

Example 57: the method of any of Examples 52-56, wherein, responsive to determining that the payload header extension of the haptics media RTP packets/PDUs does not include the importance value from the plurality of importance values, determining, with the electronic processor, whether a MIHS unit type of the payload header extension indicates that a MIHS unit is a temporal MIHS unit and a dependent MIHS unit indicates that the MIHS unit is independent, and wherein, responsive to determining that the MIHS unit type indicates that the MIHS unit is the temporal MIHS unit and the dependent MIHS unit indicates that the MIHS unit is independent, assigning, with the electronic processor, the importance value of the payload header extension to an independent temporal importance value that is higher in importance than a dependent temporal importance value and equal in importance with a spatial importance value.

Example 58: the method of any of Examples 52-57, wherein, responsive to determining that the payload header extension of the haptics media RTP packets/PDUs does not include the importance value from the plurality of importance values, determining, with the electronic processor, whether a MIHS unit type of the payload header extension indicates that a MIHS unit is a temporal MIHS unit and a dependent MIHS unit indicates that the MIHS unit is dependent, and wherein, responsive to determining that the MIHS unit type indicates that the MIHS unit is the temporal MIHS unit and the dependent MIHS unit indicating that the MIHS unit is dependent, assigning, with the electronic processor, the importance value of the payload header extension to a dependent temporal importance value that is lower in importance than an initialization importance value, a spatial importance value, and an independent temporal importance value.

Example 59: the method of any of Examples 52-58, wherein, responsive to determining that the payload header extension of the haptics media RTP packets/PDUs does not include the importance value from the plurality of importance values, determining, with the electronic processor, whether a MIHS unit type of the payload header extension indicates that that a MIHS unit is a silent MIHS unit, and wherein, responsive to determining that the MIHS unit type indicates that that the MIHS unit is the silent MIHS unit, assigning, with the electronic processor, the importance value of the payload header extension to a silent importance value that is lower in importance than a non-silent importance value.

Example 60: the method of any of Examples 52-59, wherein, responsive to determining that the payload header extension of the haptics media RTP packets/PDUs does not include the importance value from the plurality of importance values, determining, with the electronic processor, whether a MIHS unit type of the payload header extension indicates that a MIHS unit is a fragmentation unit, and wherein, responsive to determining that the MIHS unit type indicates that the MIHS unit is the fragmentation unit, determining, with the electronic processor, whether a fragmentation unit header indicates the MIHS unit type is one of an initialization MIHS unit, a spatial MIHS unit, or a temporal MIHS unit, wherein, responsive to determining that the fragmentation unit header indicates the MIHS unit type is the initialization MIHS unit, assigning, with the electronic processor, the importance value of the payload header extension to an initialization importance value that is equal to or higher in importance than a spatial importance value, wherein, responsive to determining that the fragmentation unit indicates the MIHS unit type is the spatial MIHS unit, assigning, with the electronic processor, the importance value of the payload header extension to the spatial importance value that is equal to or lower in importance than the initialization importance value, wherein, responsive to determining that the fragmentation unit indicates the MIHS unit type is the temporal MIHS unit, determining whether the MIHS unit is a dependent temporal MIHS unit or an independent temporal MIHS unit, wherein, responsive to determining that the MIHS unit is the dependent temporal MIHS unit, assigning, with the electronic processor, the importance value of the payload header extension to a dependent temporal importance value that is lower in importance than the initialization importance value, the spatial importance value, and an independent temporal importance value, and wherein, responsive to determining that the MIHS unit is the independent temporal MIHS unit, assigning, with the electronic processor, the importance value of the payload header extension to the independent temporal importance value that is equal to in importance as the spatial importance value.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well. For example, while the system has been described with reference to a 3GPP, 5G, and/or NR network layer, the envisioned embodiments extend beyond implementations using a particular network layer technology. Likewise, the potential implementations extend to all types of service layer architectures, systems, and embodiments. The techniques described herein may be applied independently and/or used in combination with other resource configuration techniques.

The processes described herein may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read-only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

It is understood that the entities performing the processes described herein may be logical entities that may be implemented in the form of software (e.g., computer-executable instructions) stored in a memory of, and executing on a processor of, a mobile device, network node or computer system. That is, the processes may be implemented in the form of software (e.g., computer-executable instructions) stored in a memory of a mobile device and/or network node, such as the node or computer system, which computer-executable instructions, when executed by a processor of the node, perform the processes discussed. It is also understood that any transmitting and receiving processes illustrated in figures may be performed by communication circuitry of the node under control of the processor of the node and the computer-executable instructions (e.g., software) that it executes.

The various techniques described herein may be implemented in connection with hardware or software or, where appropriate, with a combination of both. Thus, the implementations and apparatus of the subject matter described herein, or certain aspects or portions thereof, may take the form of program code (e.g., instructions) embodied in tangible media including any other machine-readable storage medium wherein, when the program code is loaded into and executed by a machine, such as a computer, the machine becomes an apparatus for practicing the subject matter described herein. In the case where program code is stored on media, it may be the case that the program code in question is stored on one or more media that collectively perform the actions in question, which is to say that the one or more media taken together contain code to perform the actions, but that—in the case where there is more than one single medium—there is no requirement that any particular part of the code be stored on any particular medium. In the case of program code execution on programmable devices, the computing device generally includes a processor, a storage medium readable by the processor (including volatile and non-volatile memory and/or storage elements), at least one input device, and at least one output device. One or more programs that may implement or utilize the processes described in connection with the subject matter described herein, e.g., through the use of an API, reusable controls, or the like. Such programs are preferably implemented in a high level procedural or object-oriented programming language to communicate with a computer system. However, the program(s) can be implemented in assembly or machine language, if desired. In any case, the language may be a compiled or interpreted language and combined with hardware implementations.

Although example embodiments may refer to utilizing aspects of the subject matter described herein in the context of one or more stand-alone computing systems, the subject matter described herein is not so limited, but rather may be implemented in connection with any computing environment, such as a network or distributed computing environment. Still further, aspects of the subject matter described herein may be implemented in or across a plurality of processing chips or devices, and storage may similarly be affected across a plurality of devices. Such devices may include personal computers, network servers, handheld devices, supercomputers, or computers integrated into other systems such as automobiles and airplanes.

In describing the preferred embodiments of the subject matter of the present disclosure, as illustrated in the Figures, specific terminology is employed for the sake of clarity. The claimed subject matter, however, is not intended to be limited to the specific terminology so selected, and it is to be understood that each specific element includes all technical equivalents that operate in a similar manner to accomplish a similar purpose.

What is claimed is:

1. A method comprising:
determining, with an electronic processor, haptic media characteristics;
generating, with the electronic processor, a haptics media RTP packets/PDUs based on the haptic media characteristics, the haptics media RTP packets/PDUs including a payload with haptic data and a payload header extension including an importance value from a plurality of importance values, the importance value indicating an importance of the haptic data and assign based on the haptic media characteristics; and
outputting, with the electronic processor, the haptics media RTP packets/PDUs.

2. The method of claim 1, wherein the haptic media characteristics include a MIHS unit type, a dependent MIHS unit, and MIHS unit layer information.

3. The method of claim 2,
wherein the plurality of importance values includes an independent importance value and a dependent importance value, and
wherein, based on the dependent MIHS unit indicating that a MIHS unit is independently decodable by a haptics media decoder, assigning, with the electronic processor, the importance value of the payload header extension to the independent importance value that is higher in importance than the dependent importance value.

4. The method of claim 3, wherein, based on the dependent MIHS unit indicating that the MIHS unit is not independently decodable by the haptics media decoder, assigning, with the electronic processor, the importance value of the payload header extension to the dependent importance value.

5. The method of claim 2, wherein the MIHS unit type indicates a MIHS unit is one of an initialization MIHS unit, a temporal MIHS unit, a spatial MIHS unit, a silent MIHS unit, a first aggregation packet (STAP), a second aggregation packet (MTAP), or a fragmentation unit.

6. The method of claim 5,
wherein the plurality of importance values includes an initialization importance value and a non-initialization importance value, and
wherein, based on the MIHS unit type indicating that the MIHS unit is the initialization MIHS unit, assigning, with the electronic processor, the importance value of the payload header extension to the initialization importance value that is higher in importance than the non-initialization importance value.

7. The method of claim 5,
wherein the plurality of importance values includes a spatial importance value, a dependent temporal importance value, and an initialization importance value, and
wherein, based on the MIHS unit type indicating that the MIHS unit is the spatial MIHS unit, assigning, with the electronic processor, the importance value of the payload header extension to the spatial importance value, the spatial importance value that is higher in importance than the dependent temporal importance value and lower in importance than the initialization importance value.

8. The method of claim 5,
wherein the plurality of importance values includes an independent temporal importance value, a dependent temporal importance value, and a spatial importance value, and
wherein, based on the MIHS unit type indicating that the MIHS unit is the temporal MIHS unit and the dependent MIHS unit indicating that the MIHS unit is independent, assigning, with the electronic processor, the importance value of the payload header extension to the independent temporal importance value that is higher in importance than the dependent temporal importance value and the spatial importance value.

9. The method of claim 5,
wherein the plurality of importance values includes a dependent temporal importance value, an initialization importance value, a spatial importance value, and an independent temporal importance value, and
wherein, based on the MIHS unit type indicating that the MIHS unit is the temporal MIHS unit and the dependent MIHS unit indicating that the MIHS unit is dependent, assigning, with the electronic processor, the importance value of the payload header extension to the dependent temporal importance value that is lower in importance than the initialization importance value, the spatial importance value, and the independent temporal importance value.

10. The method of claim 5,
wherein the plurality of importance values includes a silent importance value and a non-silent importance value, and
wherein, based on the MIHS unit type indicating that the MIHS unit is the silent MIHS unit, assigning, with the electronic processor, the importance value of the payload header extension to the silent importance value that is lower in importance than the non-silent importance value.

11. The method of claim 5,
wherein the plurality of importance values includes an initialization importance value, a spatial importance value, a dependent temporal importance value, and an independent temporal importance value
wherein, based on the MIHS unit type indicating that the MIHS unit is the fragmentation unit, determining, with the electronic processor, whether a fragmentation unit header indicates the MIHS unit type is one of the initialization MIHS unit, the spatial MIHS unit, or the temporal MIHS unit,
wherein, responsive to determining that the fragmentation unit header indicates the MIHS unit type is the initialization MIHS unit, assigning, with the electronic processor, the importance value of the payload header extension to the initialization importance value that is equal to or higher in importance than the spatial importance value,
wherein, responsive to determining that the fragmentation unit indicates the MIHS unit type is the spatial MIHS unit, assigning, with the electronic processor, the importance value of the payload header extension to the spatial importance value that is equal to or slightly lower in importance than the initialization importance value,
wherein, responsive to determining that the fragmentation unit indicates the MIHS unit type is the temporal MIHS unit, determining whether the MIHS unit is a dependent temporal MIHS unit or an independent temporal MIHS unit,
wherein, responsive to determining that the MIHS unit is the dependent temporal MIHS unit, assigning, with the electronic processor, the importance value of the payload header extension to the dependent temporal importance value that is lower in importance than the initialization importance value, the spatial importance value, and the independent temporal importance value, and
wherein, responsive to determining that the MIHS unit is the independent temporal MIHS unit, assigning, with the electronic processor, the importance value of the payload header extension to the independent temporal importance value that is equal to in importance as the spatial importance value.

12. A method comprising:
receiving, with a electronic processor, a haptics media RTP packets/PDUs based on haptic media characteristics, the haptics media RTP packets/PDUs including a payload with haptic data;
determining, with the electronic processor, whether a payload header extension of the haptics media RTP packets/PDUs includes an importance value from a plurality of importance values, the importance value indicating an importance of the haptic data; and
decoding, with the electronic processor, the payload from the haptics media RTP packets/PDUs based on the importance value.

13. The method of claim 12, wherein the haptic media characteristics include a MIHS unit type, a dependent MIHS unit, and MIHS unit layer information.

14. The method of claim 12,
wherein, responsive to determining that the payload header extension of the haptics media RTP packets/PDUs includes the importance value from the plurality of importance values, determining, with the electronic processor, whether the importance value is one of an initialization importance value, a spatial importance value, a dependent temporal importance value, an independent temporal importance value, or a silent importance value, and
wherein decoding, with the electronic processor, the payload from the haptics media RTP packets/PDUs based on the importance value includes decoding the payload from the haptics media RTP packets/PDUs based on the one of the initialization importance value, the spatial importance value, the dependent temporal importance value, the independent temporal importance value, or the silent importance value that is determined.

15. The method of claim 12,
wherein, responsive to determining that the payload header extension of the haptics media RTP packets/PDUs does not include the importance value from the plurality of importance values, determining, with the electronic processor, whether a MIHS unit is independently decodable by a haptics media decoder,
wherein, responsive to determining that the MIHS unit is not independently decodable by the haptics media decoder, assigning, with the electronic processor, the importance value to a dependent importance value that is lower in importance than an independent importance value, and
wherein, responsive to determining that the MIHS unit is independently decodable by the haptics media decoder, assigning, with the electronic processor, the importance value to the independent importance value.

16. The method of claim 12,
wherein, responsive to determining that the payload header extension of the haptics media RTP packets/PDUs does not include the importance value from the plurality of importance values, determining, with the electronic processor, whether a MIHS unit type of the payload header extension indicates that a MIHS unit is a spatial MIHS unit, and
wherein, responsive to determining that the MIHS unit type indicates that the MIHS unit is the spatial MIHS unit, assigning, with the electronic processor, the importance value of the payload header extension to a spatial importance value, the spatial importance value that is higher in importance than a dependent temporal importance value and lower in importance than a initialization importance value.

17. The method of claim 12,
wherein, responsive to determining that the payload header extension of the haptics media RTP packets/PDUs does not include the importance value from the plurality of importance values, determining, with the electronic processor, whether a MIHS unit type of the payload header extension indicates that a MIHS unit is a temporal MIHS unit and a dependent MIHS unit indicates that the MIHS unit is independent, and
wherein, responsive to determining that the MIHS unit type indicates that the MIHS unit is the temporal MIHS unit and the dependent MIHS unit indicates that the MIHS unit is independent, assigning, with the electronic processor, the importance value of the payload header extension to an independent temporal importance value that is higher in importance than a dependent temporal importance value and equal in importance with a spatial importance value.

18. The method of claim 12,
wherein, responsive to determining that the payload header extension of the haptics media RTP packets/PDUs does not include the importance value from the plurality of importance values, determining, with the electronic processor, whether a MIHS unit type of the payload header extension indicates that a MIHS unit is a temporal MIHS unit and a dependent MIHS unit indicates that the MIHS unit is dependent, and
wherein, responsive to determining that the MIHS unit type indicates that the MIHS unit is the temporal MIHS unit and the dependent MIHS unit indicating that the MIHS unit is dependent, assigning, with the electronic processor, the importance value of the payload header extension to a dependent temporal importance value that is lower in importance than an initialization importance value, a spatial importance value, and an independent temporal importance value.

19. The method of claim 12,
wherein, responsive to determining that the payload header extension of the haptics media RTP packets/PDUs does not include the importance value from the plurality of importance values, determining, with the electronic processor, whether a MIHS unit type of the payload header extension indicates that that a MIHS unit is a silent MIHS unit, and
wherein, responsive to determining that the MIHS unit type indicates that that the MIHS unit is the silent MIHS unit, assigning, with the electronic processor, the importance value of the payload header extension to a silent importance value that is lower in importance than a non-silent importance value.

20. The method of claim 12,
wherein, responsive to determining that the payload header extension of the haptics media RTP packets/PDUs does not include the importance value from the plurality of importance values, determining, with the electronic processor, whether a MIHS unit type of the payload header extension indicates that a MIHS unit is a fragmentation unit, and
wherein, responsive to determining that the MIHS unit type indicates that the MIHS unit is the fragmentation unit, determining, with the electronic processor, whether a fragmentation unit header indicates the MIHS unit type is one of an initialization MIHS unit, a spatial MIHS unit, or a temporal MIHS unit,
wherein, responsive to determining that the fragmentation unit header indicates the MIHS unit type is the initialization MIHS unit, assigning, with the electronic processor, the importance value of the payload header extension to an initialization importance value that is equal to or higher in importance than a spatial importance value,
wherein, responsive to determining that the fragmentation unit indicates the MIHS unit type is the spatial MIHS unit, assigning, with the electronic processor, the importance value of the payload header extension to the spatial importance value that is equal to or lower in importance than the initialization importance value,
wherein, responsive to determining that the fragmentation unit indicates the MIHS unit type is the temporal MIHS unit, determining whether the MIHS unit is a dependent temporal MIHS unit or an independent temporal MIHS unit,
wherein, responsive to determining that the MIHS unit is the dependent temporal MIHS unit, assigning, with the electronic processor, the importance value of the payload header extension to a dependent temporal importance value that is lower in importance than the initialization importance value, the spatial importance value, and an independent temporal importance value, and
wherein, responsive to determining that the MIHS unit is the independent temporal MIHS unit, assigning, with the electronic processor, the importance value of the payload header extension to the independent temporal importance value that is equal to in importance as the spatial importance value.
